(19) United States
(12) Patent Application Publication
(10) Pub. No.: US 2009/0043797 A1
(43) Pub. Date: Feb. 12, 2009

(54) System And Methods For Clustering Large Database of Documents

(75) Inventors: Vincent Joseph DORIE, San Mateo, CA (US); Eric R. GIANNELLA, Saratoga, CA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: SPARKIP, INC., Atlanta, GA (US)

(21) Appl. No.: 12/181,150

(22) Filed: Jul. 28, 2008

Related U.S. Application Data
(60) Provisional application No. 60/952,457, filed on Jul. 27, 2007.

(51) Int. Cl. G06F 17/30

(52) U.S. Cl. 707/101; 707/102; 707/E17.044

(57) ABSTRACT

In a computerized system, a method of organizing a plurality of documents within a dataset of documents, wherein a plurality of documents within a class of the dataset each includes one or more citations to one or more other documents, comprising creating a set of fingerprints for each respective document in the class, wherein each fingerprint comprises one or more citations contained in the respective document, creating a plurality of clusters for the dataset based on the sets of fingerprints for the documents in the class, assigning each respective document in the dataset to one or more of the clusters, creating a descriptive label for each respective cluster, and presenting one or more of the labeled clusters to a user of the computerized system or providing the user with access to documents in at least one cluster.

### CROSS-REFERENCE TO RELATED PATENT APPLICATION

This application Claims priority to and the benefit of, pursuant to 35 U.S.C. 119(e), U.S. provisional patent application Ser. No. 60/952,457, filed Jul. 27, 2007, entitled “System for Clustering Large Database of Technical Literature,” by Vincent J. Dorie and Eric R. Giannella, which is incorporated herein by reference in its entirety.

Some references, if any, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference.

### FIELD OF THE INVENTION

The present inventions relate generally to organizing documents. More particularly, they relate to segmenting, organizing, and clustering of large databases or datasets of documents through the advantageous use of cross-references and citations within a class or subset of documents within the entire database or dataset.

### BACKGROUND OF THE INVENTION

Intellectual capital is increasing in importance and value as traditional skills and assets are commoditized in our networked global economy. Intellectual capital provides a foundation for building a successful knowledge-based economy in the 21st century. Recognition of this value is perhaps most clearly seen in the dramatic increase in patent filings with the U.S. Patent and Trademark Office. From 1997 to 2005, the number of new patents filed increased 80% to Over 417,000 per year. And during the same period, total R&D investment in the U.S. increased from $231.3 billion to $288.8 billion. Meanwhile, global licensing revenue from intellectual property is enormous—estimated at over $100 billion per year. Despite this figure, the licensing of intellectual property (IP) offers tremendous potential for growth. The business of technology licensing is built on fragmented personal networks, sometimes overwhelming and confusing information about intellectual property fights, and can be a very slow and costly processes. Unlike markets for most other assets, such as raw materials, equities, currencies, human skills, and consumer goods, a more established market of rules, best practices, transparency and established value is needed for intellectual property.

U.S. Universities are an important component of the $100 billion worldwide IP licensing market. The U.S. federal government invests approximately $47 billion a year in university research grants, an investment that has been widely credited with driving innovation in our society. However, this $47 billion annual investment only generates $1.4 billion in annual license revenue across 4,800 license deals—a yield of less than 3%. The licensing of university IP is without an efficient market, system. The buyer community may be frustrated at the lack of visibility into new inventions and R&D activity within the universities. At the same time, faculty scientists may feel that the patenting process (drafting, filing, and prosecuting) is too time-consuming. Further, most university technology transfer offices are understaffed and overworked. There is a great need for innovative tools for capturing, protecting, and marketing inventions in order to catalyze U.S. University licensing and commercialization. Similarly, many of the difficulties encountered by government research institutions, foreign universities, and corporate licensors could be remedied through the application of these same tools.

There is a need for an electronic exchange for intellectual property to address and capitalize on many of the shortcomings of the current market model. Further, there is a need to enable the millions of patents and new innovations to be viewed, analyzed, and involved in transactions in an effective, efficient, and user-friendly way. Preferably, this would occur through one or more electronic exchanges that could provide the world's inventors, technology sellers, and technology buyers with a comprehensive and easy to use IP marketplace. There is a need for specialized tools to enable inventors and sellers to target, their research and development activities, identify collaborators and complementary technology, manage the patent protection process, and market inventions to the buyer community in an improved way. Moreover, there is a need for a system that provides inventors, sellers and buyers with powerful new information and functionality for doing their jobs. There therefore is a need for a system for organizing and relating patents and technologies in more fine-grained and descriptive, ways than previously thought possible. There is a further need for a system by which buyers and sellers are able to visually navigate across a vast map of new technologies within the context of the entire patent landscape. There is a further need, given the vast growth in the amount of information and documents available throughout the world today, for a way of segmenting, organizing, and clustering large databases of any type of documents.

Therefore, a heretofore unaddressed need exists in the art to address the aforementioned deficiencies and inadequacies.

### SUMMARY OF THE INVENTION

The present invention, in one aspect, relates to a method of organizing a plurality of documents for later access and retrieval within a computerized system, where the plurality of documents are contained within a dataset and where a class of documents contained in the dataset include one or more citations to one or more other documents. In one embodiment, the method includes the steps of creating a set of fingerprints for each respective document in the class, where each fingerprint has one or more citations contained in the respective document, creating a plurality of clusters for the dataset based on the sets of fingerprints for the documents in the class, and assigning each respective document in the class to zero or more of the clusters based on the set of fingerprints for the respective document, where each respective cluster has documents assigned to it based on a statistical similarity between the sets of fingerprints of the assigned documents. The method further has the steps of, for each remaining document in the dataset that has not yet been assigned to at least one cluster, assigning each remaining document to one or more of the clusters based on a natural language processing comparison of each remaining document with documents already assigned to each respective cluster, creating a descriptive label for each respective cluster based on key terms contained in the documents assigned to the respective cluster, and presenting one or more of the labeled clusters to a user of the computerized system.

The dataset includes one or more of issued patents, patent applications, technical disclosures, and technical literature. The citation is a reference to an issued patent, published patent application, case, lawsuit, article, website, statute, regulation, or scientific journal. The citations can reference documents only in the dataset. Alternatively, the citations reference documents both in and outside of the dataset.

Each fingerprint can further include a reference to the respective document containing the one or more citations. The set of fingerprints for each respective document can be based on all of the citations contained in the respective document. Alternatively, the set of fingerprints for each respective document can be based on a sampling of the citations contained in the respective document. The step of creating the plurality of clusters for the dataset can be based on the sets of fingerprints for only a subset of documents in the class.

The method can further include the steps of identifying spurious citations contained in documents in the class and excluding the spurious citations from consideration during the step of creating the set of fingerprints. This causes some documents to be excluded from the class. Alternatively, the method can further include, the steps of identifying spurious citations contained in documents in the class and then excluding any documents having spurious citations from the class.

The method can further include the step of identifying spurious citations contained in documents in the class, where spurious citations include citations that are part of a spam citation listing, are a reference to a key work document, or are a reference to another document having an overlapping relationship with the document containing the respective citation. The spam citation listing includes a list of citations that are repeated in a predetermined number of documents. The key work document is a document cited by a plurality of documents that exceeds a predetermined threshold. The overlapping relationship can include the same inventor, assignee, patent examiner, title, or legal representative between the document referenced by the respective citation and the document containing the respective citation. Alternatively, the overlapping relationship can include the same author, employer, publisher, publication, source, or title between the document referenced by the respective citation and the document containing the respective citation.

The method can further include the step of reducing the plurality of clusters by merging pairs of clusters as a factor of the similarity between documents assigned to the pairs of clusters and the number of documents assigned to each of the pairs of clusters. The merging of pairs of clusters is accomplished as a factor of the difference in the number of documents assigned to each of the pairs of clusters. The method can further include the step of reducing the plurality of clusters by progressively merging pairs of lower level clusters to define a higher level cluster. Also, the method can include the step of assigning each respective document in the class to zero or more of the clusters based on an n-step analysis of documents cited directly or transitively by each respective document.

The plurality of clusters can be arranged in hierarchical format, with a larger number of documents assigned to higher-level clusters and with fewer documents assigned to lower-level, more specific clusters. The step of creating descriptive labels for each respective cluster includes creating general labels for the higher-level clusters and progressively more specific labels for the smaller, lower-level clusters, where the step of creating descriptive labels for each respective cluster is performed in a bottom-up and top-down approach. The descriptive label for one of the respective clusters can include at least one key term from the documents assigned to the respective cluster. Alternatively, the descriptive label for one of the respective clusters is derived from but does not include key terms from the documents assigned to the respective cluster.

The method step of assigning each remaining document to one or more of the clusters based oh the natural language processing comparison includes comparing key terms contained in each of the remaining documents with key terms contained in documents already assigned to each respective cluster. This step can include running a statistical n-gram analysis.

The method step of presenting one or more of the labeled clusters to the user can include displaying the labeled clusters to the user oh a computer screen. The user can be provided with access to one or more of the documents assigned to the one or more of the labeled clusters. Alternatively, the user can be provided with access to only portions of the documents assigned to the one or more labeled clusters. The presentation can be in response to a request by the user.

In another aspect, the present invention relates to a method of organizing documents in a dataset of a plurality of documents, in a computerized system, where a class of documents contained in the dataset includes one or more citations to one or more other documents. In one embodiment, the method includes the steps of, for each document in the class, creating a set of fingerprints, where each fingerprint identifies one or more citations contained in the respective document, and, based on the sets of fingerprints for the documents in the class, creating a plurality of clusters for the dataset, where each cluster is defined as ah overlap of fingerprints from two or more documents in the class. The method further includes the steps of assigning documents in the class to zero of more of the clusters based on the citations contained in each respective document, assigning all remaining documents in the dataset, that have not yet, been assigned to at least one cluster, to one or more clusters based on a natural language processing comparison of each remaining document with documents, already assigned to each respective cluster, creating a label for each respective cluster based on key terms contained in the documents assigned to the respective cluster, and providing to a user of the computerized system access to documents assigned to one or more clusters in response to a request by the user.

The dataset includes one or more of issued patents, patent applications, technical disclosures, and technical literature. The citation is a reference to an issued patent, published patent application, case, lawsuit, article, website, statute, regulation, or scientific journal. The citations can reference documents only in the dataset. Alternatively, the citations reference documents both in and outside of the dataset.

Each fingerprint can further include a reference to the respective document containing the one or more citations. The set of fingerprints for each respective document can be based on all of the citations contained in the respective document. Alternatively, the set of fingerprints for each respective document can be based on a sampling of the citations contained in the respective document. The step of creating the plurality of clusters for the dataset can be based on the sets of fingerprints for only a subset of documents in the class.

The method can further include the steps of identifying spurious citations contained in documents in the class and excluding the spurious citations from consideration during the step of creating the set of fingerprints. This causes some documents to be excluded from the class. Alternatively, the method can further include the steps of identifying spurious citations contained in documents in the class and then excluding any documents having spurious citations from the class.

The method can further include the step of identifying spurious citations contained in documents in the class, where spurious citations include citations that are part of a spam citation listing, are a reference to a key work document, or are a reference to another document having an overlapping relationship with the document containing the respective citation. The spam citation listing includes a list of citations that are repeated in a predetermined number of documents. The key work document is a document cited by a plurality of documents that exceeds a predetermined threshold. The overlapping relationship can include the same inventor, assignee, patent examiner, title, or legal representative between the document referenced by the respective citation and the document containing the respective citation. Alternatively, the overlapping relationship can include the same author, employer, publisher, publication, source, or title between the document referenced by the respective citation and the document containing the respective citation.

The method can further include the step of reducing the plurality of clusters by merging pairs of clusters as a factor of the similarity between documents assigned to the pairs of clusters and the number of documents assigned to each of the pairs of clusters. The merging of pairs of clusters is accomplished as a factor of the difference in the number of documents assigned to each of the pairs of clusters. The method can further include the step of reducing the plurality of clusters by progressively merging pairs of lower level clusters to define a higher level cluster. Also, the method can include the step of assigning each respective document in the class to zero or more of the clusters based on an n-step analysis of documents cited directly or transitively by each respective document.

The plurality of clusters can be arranged in hierarchical format, with a larger number of documents assigned to higher-level clusters and with fewer documents assigned to lower-level, more specific clusters. The step of creating descriptive labels for each respective cluster includes creating general labels for the higher-level clusters and progressively more specific labels for the smaller, lower-level clusters, where the step of creating descriptive labels for each respective cluster is performed in a bottom-up and top-down approach. The descriptive label for one of the respective clusters can include at least one key term from the documents assigned to the respective cluster. Alternatively, the descriptive label for one of the respective clusters is derived from but does not include key terms from the documents assigned to the respective cluster.

The method step of assigning each remaining document to one or more of the clusters based on the natural language processing comparison includes comparing key terms contained in each of the remaining documents with key terms contained in documents already assigned to each respective cluster. This step can include running a statistical n-gram analysis.

The method step of providing to the user of the computerized system access to documents assigned to one or more clusters can include displaying the documents to the user on a computer screen, and the user may be provided with access to only portions of the documents. This step of can include first presenting the one or more clusters to the user.

In yet another aspect, the present invention relates to a method, in a computerized system, of organizing documents for later, access and retrieval within the computerized system, where the plurality of documents are contained within a dataset and where a class of documents contained in the dataset include one or more citations to one or more other documents. In one embodiment, the method includes, the steps of identifying spurious citations contained in documents in the class, creating a set of fingerprints for each document in the class, where each fingerprint identifies one or more citations, other than spurious citations, contained in the respective document, and creating an initial plurality of low-level clusters for the dataset based on the sets of fingerprints for the documents in the class, where each cluster is defined as an overlap of fingerprints from two or more documents in the class. The method further includes the steps of creating a reduced plurality of high-level clusters by progressively merging pairs of low-level clusters to define a respective high-level cluster, assigning documents in the dataset to one or more of the clusters, creating a label for each respective cluster based on key terms contained in the documents assigned to the respective cluster, and selectively presenting one or more of the low-level and high-level clusters to a user of the computerized system.

The method can further comprise the step of identifying spurious citations contained in documents in the class, where spurious citations include citations that are part of a spam citation listing, are a reference to a key work document, or are a reference to another document having an overlapping relationship with the document containing the respective citation. The spam citation listing is a list of citations that are repeated in a predetermined number of documents. The key work is a document cited by a plurality of documents that exceeds a predetermined threshold. The overlapping relationship can include the same inventor, assignee, patent examiner, title, or legal representative between the document referenced by the respective citation and the document containing the respective citation. Alternatively, it can include the same author, employer, publisher, publication, source, or title between the document referenced by the respective citation and the document containing the respective citation.

The step of selectively presenting one or more of the low-level and high-level clusters to a user includes providing the user with access to one or more of the documents assigned to the one or more of the low-level and high-level clusters. Alternatively, it includes providing the user with access to portions of the documents assigned to the one or more of the low-level and high-level clusters. This can be in response to a request by the user.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of ah embodiment, and wherein:

FIG. 1 shows schematically a diagram of a computerized system, according to one embodiment of the present invention;

FIG. 2 shows schematically a diagram of a dataset and an inner subset, according to another embodiment of the present invention;

FIG. 3 shows schematically a flow chart of a clustering process, according to one embodiment of the present invention;

FIG. 4 shows schematically a flow chart of a format process, according to yet another embodiment of the present invention;

FIG. 5 shows schematically a flow chart of a process for classifying similar patents, according to yet another embodiment of the present invention;

FIG. 6 shows schematically a flow chart of a process for trimming commonly cited patents, according to yet another embodiment of the present invention;

FIG. 7 shows schematically a flow chart of a fingerprinting process, according to yet another embodiment of the present invention;

FIG. 8 shows schematically a flow chart of a cluster process, according to yet another embodiment of the present invention;

FIG. 9 shows schematically a flow chart of a merge process, according to yet another embodiment of the present invention;

FIG. 10 shows schematically a flow chart of a slice process, according to yet another embodiment of the present invention;

FIG. 11 shows schematically a flow chart of a beam process, according to yet another embodiment of the present invention;

FIG. 12 shows schematically a flow chart of a graph closure process, according to yet another embodiment of the present invention;

FIG. 13 shows schematically a flow chart of a connect patents process, according to yet another embodiment of the present invention;

FIG. 14 shows schematically a flow chart of a connect clusters process, according to yet another embodiment of the present invention;

FIG. 15 shows schematically a flow chart of a cluster import process, according to yet another embodiment of the present invention;

FIG. 16A shows schematically a diagram of a patent and its backward citations, according to yet another embodiment of the present invention;

FIG. 16B shows schematically a diagram of a first shingle of the patent of FIG. 16A, according to yet another embodiment of the present invention;

FIG. 16C shows schematically a diagram of a first and second shingle of the patent of FIG. 16B, according to yet another embodiment of the present invention;

FIG. 17A shows schematically a diagram of another patent and related citations, according to yet another embodiment of the present invention;

FIG. 17B shows schematically a diagram of yet another patent and related citations, according to yet another embodiment of the present invention;

FIG. 17C shows schematically a diagram of a cluster of the patents and related citations from FIGS. 17A and 17B;

FIG. 18 shows schematically an overview flow chart of the cluster naming process, according to yet another embodiment of the present invention;

FIG. 19 shows schematically a flow chart of a parsing HTML process, according to yet another embodiment of the present invention;

FIG. 20 shows schematically a flow chart of an extracting sentences process, according to yet another embodiment of the present invention;

FIG. 21 shows schematically a flow chart of a creating n-gram maps process, according to yet another embodiment of the present invention;

FIG. 22 shows schematically a flow chart of a labeling hierarchy process, according to yet another embodiment of the present invention;

FIG. 23 shows schematically a flow chart of a label import process, according to yet another embodiment of the present invention;

FIG. 24 shows schematically a flow chart of a labeling clarification process, according to yet another embodiment of the present invention;

FIG. 25A shows schematically a diagram of a cluster for a cluster merging process, according to yet another embodiment of the present invention;

FIG. 25B shows schematically a diagram of a further, step, of the cluster merging process of FIG. 25A, according to yet another embodiment of the present invention;

FIG. 25C shows schematically a diagram of a further step of the cluster merging process of FIG. 25B;

FIG. 25D shows schematically a diagram of a further step of the cluster merging process of FIG. 25C;

FIG. 25E shows schematically a diagram of a final step of the cluster merging process of FIGS. 25A-D;

FIG. 26 shows schematically a diagram of a cluster hierarchy, according to yet another embodiment of the present invention;

FIG. 27 shows schematically a flow chart of cluster-cluster links, according to yet another embodiment of the present invention;

FIG. 28 shows schematically a flow chart of an aggregated patent citation count process, according to yet another embodiment of the present invention;

FIG. 29 shows schematically a weighted patent citation process, according to yet another embodiment of the present invention;

FIG. 30 shows schematically a flow chart of influence from patent citations, according to yet another embodiment of the present invention;

FIG. 31 shows schematically a chartof a sample of patent filings in a cluster over time, according to yet another embodiment of the present invention;

FIG. 32 shows schematically a diagram of a network of clusters at a first point in time, according to yet another embodiment of the present invention;

FIG. 33 shows schematically a diagram of a network of clusters at a second point in time, according to yet another embodiment of the present invention;

FIG. 34 shows schematically a diagram of an intergenerational map between the clusters at a first point in time, as shown in FIG. 32, and the clusters at a second point in time, as shown in FIG. 33, according to yet another embodiment of the present invention; and

FIG. 35 shows schematically an example embodiment of an intergenerational map of clusters made for multiple years, according to yet another embodiment of the present invention.

### DETAILED DESCRIPTION OF THE INVENTION

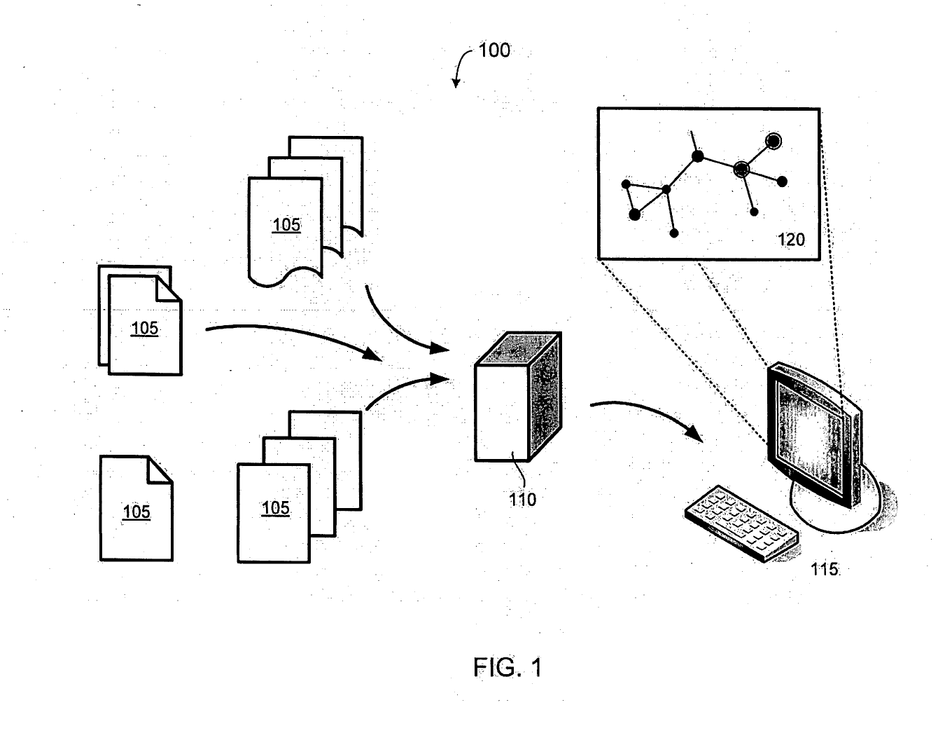

As shown in FIG. 1, a preferred embodiment of the present invention exists in a computerized system 100 in which a large volume or plurality of documents 105 are analyzed and organized into meaningful clusters by a central processor 110 so that a user (hot shown) of the computer system 100 is able to review, search, analyze, sort, identify, find, and access (i) desired “clusters” of documents (i.e., an organized group or collection of similar or related documents) or (ii) desired one or more specific documents using a computer or other interface 115 in communication with the central processor 110 or with access to an output generated or provided by the central processor 110. In one embodiment, the computer or interface 115 displays representations 120 of the desired clusters of documents or the desired one or more specific documents, for example, on a screen of the computer or other interface 115.

As will be used herein, a “citation” is a reference from one document to another “cited” document, wherein the reference provides sufficient detail to identify the cited document uniquely. The citation could be to a scientific journal or publication, lawsuit, reported case, statute, regulation, website, article, or any other document. The citation could also be to an issued patent, published patent application, or other invention or technology disclosure. In this context, a technical disclosure is any public distribution of information about an invention or technology. The technical disclosure could be in the form of an Invention Disclosure Form (IDF), a defensive publication of an idea, of any other, documentation that discloses an innovative concept. Further, the citation could also be any reference that creates a connection or relationship between the two documents.

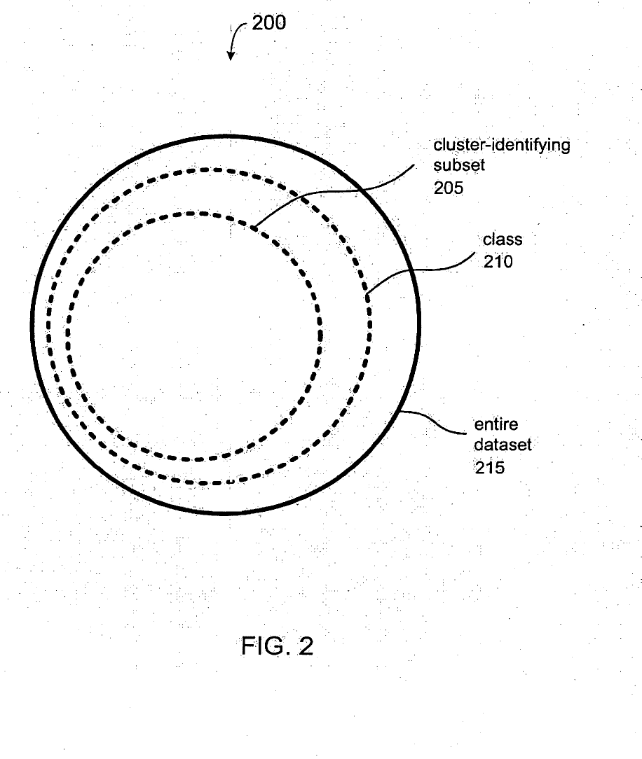

FIG. 2 illustrates schematically a collection 200 of a plurality of documents that are available for analysis and organization into meaningful clusters by the system and methods of the present invention. As will be explained herein and as will become apparent from the following discussion, the entire dataset 215 of a plurality of documents that make up the collection 200, particularly if a large volume of the documents are comprised of issued patents, patent applications of other technical literature, it is highly likely that a class 210, of less than all of the documents in the entire dataset 215, includes documents that contain citations to one or more other documents. Such cited documents can be part of the dataset 215, but do not have to be. For example, such cited documents can be outside of the dataset 215. As will also be explained hereinafter, all of the documents in the class 210 can be used by the central processor 110 to identify or create the clusters relevant to the dataset 215. Alternatively, a subset 205 of the class can be used by the central processor 110 to identify or create the clusters relevant to the entire dataset 215.

Although the present invention can be practiced in relation to all types of documents, for illustrative purposes it will be described hereinafter in connection with preferred embodiments related to intellectual property, and particularly patents.

Analysis of Large Human-Formed Networks and Technical Literature

In order to provide a robust and functional IP marketplace, there is a need for clustering the modern patent and article collection into useful groups that are more specific and sensitive than those obtained by previous efforts, such as word or key term searches, or through the U.S. Patent & Trademark Office (USPTO) classification system. The task of clustering and analyzing such a patent and article collection faces at least three major challenges. The first of these is scale. The complexity of comparing a set of characteristics between each document in a massive dataset to every other document creates significant optimization problems that cannot easily be circumvented merely through the use of more powerful hardware or through parallelization. The second challenge can generally be described as one of ambiguity of intended meaning and shortcomings in the data that is available to describe the contents of documents. This challenge relates to both the structured and unstructured data available in patents and scientific literature. The third challenge is how to best group and label documents in a manner that is useful to technical professionals and businesspeople.

Numerous previous efforts at textual clustering of patents have produced mixed results, which suggests that a route other than use of “terms” or words in patents, at least as the primary basis of clustering, is needed. For this reason, the present system described herein focuses on use and analysis of patent references and cross-references. A benefit of using patent references is that they may be explicit declarations, by the inventor, the patent attorney, or the Patent Office, that some prior work is relevant to the invention at hand, which thus requires much less guess work as compared to determining which terms serve as a good basis for associating patents.

Surprisingly, references provide a little-explored means of classifying documents. References are widely used to rank documents—both in terms of their impact (e.g., Web of Science, CiteSeer) and relevance (e.g., Google). Practitioners also use references manually to identify similar documents, although the citations provided by one article or patent may not be an exhaustive list of all the pertinent background material. This is largely due to individual differences in what makes a reference valid, scope of awareness of the literature that could be cited, and other human factors. For these reasons, in addition to the oversights and biases in citations, that developers of software for visualizing a document can rely on the “network of citations” to determine the location of each document. This approach to analyzing citations mitigates the impact of the failure of one document to miss important citations or the product of citations to weakly related documents. While these effects are diminished at a very general level, the distortion caused by missing and dubious citations becomes extremely pronounced at the level of specificity that is useful to researchers and practitioners.

As will be appreciated by patent practitioners and others skilled in the art, certain companies or inventors may have “spammed” citations within the field of patents relating to rapid prototyping, as used as an exemplary topic for reference. Such spamming of references can interfere with clustering efforts. As used herein, “spam” is used to mean the citation to patents and other prior patent references that have little or no actual relevance to the citing patent. Spam of great concern includes highly repetitive and meaningless citations that a group of patents might make. For example, instead of citing a dozen of even a few dozen relevant patents, a troublesome patent might make references to a few hundred patents, where their references may differ very little from patent to patent, despite differences in the technology being discussed. This is problematic because such patents generate specious signatures. This can lead to clusters of documents that are largely due to one company merely copying and pasting references across patent filings, when, in fact, such references represent “noise” rather than meaningful data or relationships. Spam classifiers that analyze patents for similarity in their citations are accordingly addressed in one or more aspects of the present invention.

A second issue associated with the field of patents is that “key” inventions in a field of technology may be widely recognized by most participants in the art. This can means that a small group of patents might receive several hundred citations. For example, Charles Hull built the first working rapid prototyping system in 1984, in his spare time while working at Ultraviolet Light Product, Inc. The system was based on curing liquid plastic with a UV laser layer by layer (a platform would descend allowing the next liquid layer to flow over the cured plastic). The fact that this was the first working system and that it was eventually commercialized made it widely recognized within the community, particularly because Hull went on to start the most successful rapid prototyping company, 3D Systems, Inc. Hull's 1984 patent was cited several hundred times by a variety of groups. Even organizations like MIT and Stratasys Corp., whose technology was fundamentally different in approach, cited this preeminent Hull patent. These citations represent an acknowledgment that a previous technology has a similar application. Effective clustering requires identification of technologies that are similar in nature and not just application. For this reason, histograms of the citations to patents in a field can be plotted and a reasonable number of citations for a highly cited patent within a technically similar community can be determined. This process removes outliers represented by patents such as the Hull patent. These broadly cited patents can group with moderately cited patents to form a signature that leads to the association of technologically dissimilar inventions.

“Self-citations,” can be another significant problem for citation analysis. Inventors, patent attorneys, and patent examiners may often rather cite material that is already familiar to them rather than seek out unknown material that may be more pertinent. Thus, it is important to discount the citations that span patents that share an inventor, patent examiner, assignee, or attorney. While completely dropping the citations may be a first step, it is more accurate to estimate the probability that a citation is legitimate despite the citing and cited patents sharing particular characteristics, using this probability as a weight.

Given the above discussion, in the system and methods of the present invention, these human shortcomings and intentional attempts to mislead are taken into account in the methods for removing citations. The same thinking is extended to the analysis of the text of patents, which may be used effectively for “labeling,” as described herein, and which may also be used in conjunction with citations for clustering.

After removing bad signals from a dataset, it is necessary to place die documents into groups that are thematically and technically coherent. Strategically, with regard to clustering technical literature, it is advantageous to start with very small, narrowly defined groups whose homogeneity is fairly certain. These are then amalgamated into larger groups until it can be determined that they no longer cover similar subject matter. A first step in grouping the data at a very specific level is referred to as “fingerprinting,” or using two shared citations as a signal that is sufficient to merit associating patents. This approach is derived from the process of shingling, which is a computationally inexpensive and accurate way of clustering within very large graphs using random samples of size n. See, for example, Gibson, D.; Kumar, R.; Tomkins, A., “Discovering Large Dense Subgraphs in Massive Graphs” Proceedings of the 31st International Conference on Very Large Databases, 2005, which is herein incorporated by reference in its entirety. Generally described, shingling takes multiple, small random samples of data in order to create a broad-strokes topology of a set of documents. The present invention, in one or more aspects, modifies this approach to take the full set of citations within a document to create pairs from all possible combinations of citations.

While many citations in technical literature are of questionable relevance, the chances that two unrelated documents (barring that they share the same authors or organization) have the exact same pair of citations is extremely low. Another benefit to fingerprinting is that it is computationally inexpensive, relative to full-text term comparisons or direct comparison of the citations of every patent to those of every other patent. This modified approach to shingling is hereinafter referred to as “document fingerprinting.”

Because fingerprinting produces highly specific groupings of documents that share the same pair of citations, it may not capture all of the documents that should be contained in a homogenous group. Accordingly, two additional approaches have been developed to capture other highly similar documents. The first of these approaches clusters fingerprints into specific groups, while the second merges those clusters into a hierarchy of increasingly broad concepts. The shared occurrence of fingerprints by some set of patents suggests a conceptual similarity. The first “pass” of clustering leverages this understanding and declares the set of patents associated with a single fingerprint as a “cluster,” albeit a particularly small one. At such a low level, clusters are overly specific, and so it is advantageous to use a greedy agglomerative function to group fingerprints with similar sets of patents into larger units. The output of this process is a collection of clusters encapsulating the informative and highly specific citation patterns surrounding individual technologies.

The merging process is used to group these technology clusters into broader sets representing fields of innovation. In one aspect, the present system and methodologies are based on overlap in membership between groups of patents within each cluster. Beyond a certain overlap of members, two groups will be merged. The preferred merging process used herein is based on the well-accepted Jaccard set similarity function, defined as the intersection/union. For example, two clusters, of size 20 with a 10 patent overlap will have a similarity of 10/30, or 33%. One problem is merging clusters that exhibit a significant difference in their number of patents. For example, if 5% was considered to be a fairly low similarity, in the case of a group of 10 patents and another group of 95 patents that share a five patent overlap, they will have a similarity of 5/100, or 5%, even though half the entire smaller group was contained in the larger group. Accordingly, to address this issue, a similarity function was developed that is proportional to overlap expressed by the smaller cluster, but that decays exponentially as the size disparity grows. This decay prevents a cluster from reaching ascertain mass and absorbing smaller clusters because of the thematic breadth afforded by containing vastly more patents. The similarity criteria in this merging process can be lowered to create a hierarchy of clusters that are within the same broad domain.

Because most of the processes in clustering the patent graph can be linearized, such an approach can also be scaled to deal with the much larger pool of data represented by scientific literature. The massive expansion step of generating the groups based on fingerprints is probably the most computationally difficult process. For each patent there are n!/2(n−2)! fingerprints—where n is the number of references in the patent. This means that for a patent with 40 references, 780 fingerprints (i.e. 40*39/2) are generated. If computational power is limited or if speed is necessary, one can artificially cap or limit the number of maximum fingerprints that can be assigned to any one patent and take a random citation sample that corresponds with the maximum number of references for a patent that can be considered. For example, if 40 is chosen as the maximum number of references that will be considered for any single patent, the above-described patent clustering process runs smoothly on a dual core machine with eight gigabytes of RAM and fast hard disks. However, since citations in journal articles are typically of higher quality and relevance than patent citations and cross-citations, it may be less desirable to artificially cap of limit the number of citations for such articles.

Using the above processes and methodologies, a clustering of the entire “modern” U.S. patent graph (approximately 4 million patents) can be generated and labels can be produced for each of the resulting hierarchies. Approximately 600,000 patents can be clustered using stringent similarity criteria, where the rest are not similar enough to be included in any cluster. These 600,000 patents form a core set that provides the highest quality and strongest signal for form a of the clusters and the relationship between clusters. Most of the patents that fail to be included in the resulting clusters are removed in a) the shingling step—that is they share no pairs of citations with a significant number of patents and/or b) the merging step, in which they fail to be grouped with larger clusters and are too small to survive alone.

The output of the merging process on the low level clusters of these patents generates a hierarchy of approximately 100,000 clusters, with approximately 40,000 clusters at the root. Since many of the merge steps are between sets with trivially high similarity, these were deemed to be less informative and extract cross sectional sub-graphs from the hierarchy. Many patents fail to be clustered due to a) lack of citations, b) removal of citations during spam elimination, of c) lack of a fingerprint in common with a sufficient number of patents. It is believed that the two citation fingerprint eliminates a massive amount of weak signal that could lead to many poor clusters.

Because most of the patent graph is then missing from the original cluster results, it becomes necessary to associate the removed patents with the strong clusters that are already generated; although it is possible that there could be relevant clusters that are not identified by the 600,000 strong references, the number of such possible clusters is negligible. In the first part of this process, a probability space for each patent is created by following its references out three steps. At each step, the references are further divided. After it has been traced to where a patent might land if it took a random walk three steps backward, all the probabilities by cluster are summed. If a patent hits enough clusters beyond a threshold, it is assigned to multiple memberships. If it does not meet this threshold, it is simply assigned it to its top cluster.

Even after associating patents through the citation graph, there are still some patents missing from clusters because they fail to make any citations that can be used to associate them. For these remaining patents, an N-gram profile (the derivation of which is explained below) is used to match each such patent to a cluster with the most similar N-gram profile. This cluster might be at any level of a hierarchy.

The hierarchy of clusters generated by merging them until they hit a threshold similarity is beneficial to end-users in numerous ways, but first its relevance for labeling will be focused upon. As previously discussed, one of the problems of textual analysis is the lack of knowledge about the context within which a term is used, and the subsequent impact that this has on determining the intended meaning of the term. Because terms are extracted from within pre-defined hierarchies of documents that are already known to be related in content, there is a much smaller chance that terms have completely different meanings and, thus, the system can trust a much lower term frequency to be a useful signal. Furthermore, the threshold can be reduced, of member and citation overlap, for bottom level members of a hierarchy to be merged with one another. In addition, given that the bottom of a hierarchy and the top of the hierarchy are likely to represent different levels of generality, comparison of top (context) and bottom (discrete areas) labels across hierarchies can lead to merging of clusters with moderate citation and membership similarity, but with high textual similarity. Thus, clusters from different hierarchies that lack similar fingerprints can be compared and considered for merging.

Regular expressions are a flexible means for identifying document structure. These can be designed to extract parts of the text that correspond with particular section(s) of a document or documents. For example, in the case of patent data, the title and abstract may be misleading, and the claims may be too general and not contain enough technical terms to be useful. Also, “examples” contained with the text of a patent contained substantial “noise” terms and words that are not helpful for purposes of clustering. Other sections of a typical patent document, such as Field of the Invention, Background of the Invention, and Detailed Description of the Invention can provide useful text for analysis.

Labeling of clusters and hierarchies can be improved by basing initial grouping of documents on strong co-citation criteria. Whereas clustering by textual analysis is inherently redundant in its grouping and subsequent labeling of clusters, thereby increasing the likelihood that non-salient terms are the basis for grouping and labeling documents, the present system and approaches rely on high co-occurrence of expert opinions of which documents have been built upon the same ideas. This initial grouping based on stringent citation criteria forces clusters to be labeled based on frequency of terms in documents that subject matter experts have defined as highly similar. Thus, labels are made more accurate, since they are extracted from documents that are recognized to be fairly homogeneous in their content. Accordingly, even if variations in terminology lower the frequency of salient terms, the system is better able to identify truly salient terms due to a higher confidence in the signal from each cluster.

In order to identify candidate labels, the system first analyzes n-grams, or a set of terms with n members in the full-text of every patent in a hierarchy. Each n-gram is scored on the basis of its independence (or whether it consistently appears next to particular words or is context insensitive), its distribution across the patents in a cluster, number of occurrences, and its length.

A set of terms is associated with each cluster in the hierarchy, based on all the patents contained in the cluster. This means that, at the top level, each patent in the entire hierarchy will be used for extracting terms.

The labeling of clusters uses a hierarchy that increases in specificity as the system proceeds from the top (most general) cluster to the bottom (smallest and most specific clusters). This allows the system to identify very general terms that appear throughout the hierarchy and terms that are unique to a particular cluster. In order to apply this to labeling, labels are compared between clusters at a particular level of the hierarchy, and shared terms are stored and moved up as potential higher level labels. This process continues until the most general terms are applied to the top level of the hierarchy and the most specific are applied to the lowest level. The next best terms are then tried at different levels of the hierarchy and the total score of the hierarchy is re-computed, until the optimal set of labels for the entire hierarchy (having the maximum total score) is found.

The result is that the top-level cluster contains the most common, or general, descriptions of the entire hierarchy. As the labeling process proceeds down the hierarchy, a set of terms is associated with each cluster, and each term associated with a level of the hierarchy is excluded as a potential term for describing lower levels of the hierarchy. This results in more specific labels being applied to lower levels of the hierarchy. Each cluster in the hierarchy has a corresponding score that is based on its n-gram scores. A total score for the entire hierarchy is the sum of all the cluster scores, with both children being allocated the same total weight as their parent. In order to determine the optimal set of labels spanning the entire hierarchy, the intermediate level clusters are re-labeled with their second best terms, causing all the subsidiary clusters to be relabeled, as well. After each step, the total hierarchy score is recomputed and the new labels are saved if they resulted in a higher total score. This process proceeds iteratively down the hierarchy, minimizing the name collisions through the hierarchy by enforcing ancestral and sibling consistency. The process is then checked across the cross-section of hierarchy clusters that will be presented to users to verify that no clusters have the same label. If these cluster labels are the same, child labels are added until they are unique, across all clusters.

### Clustering Overview

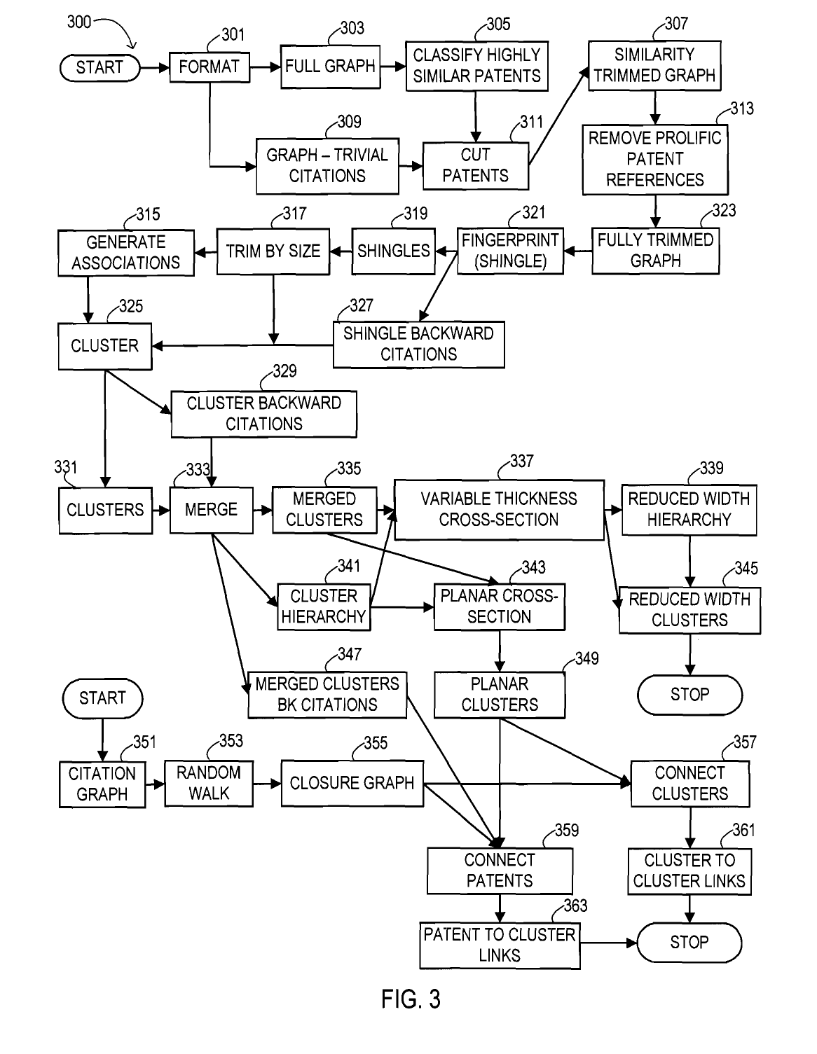

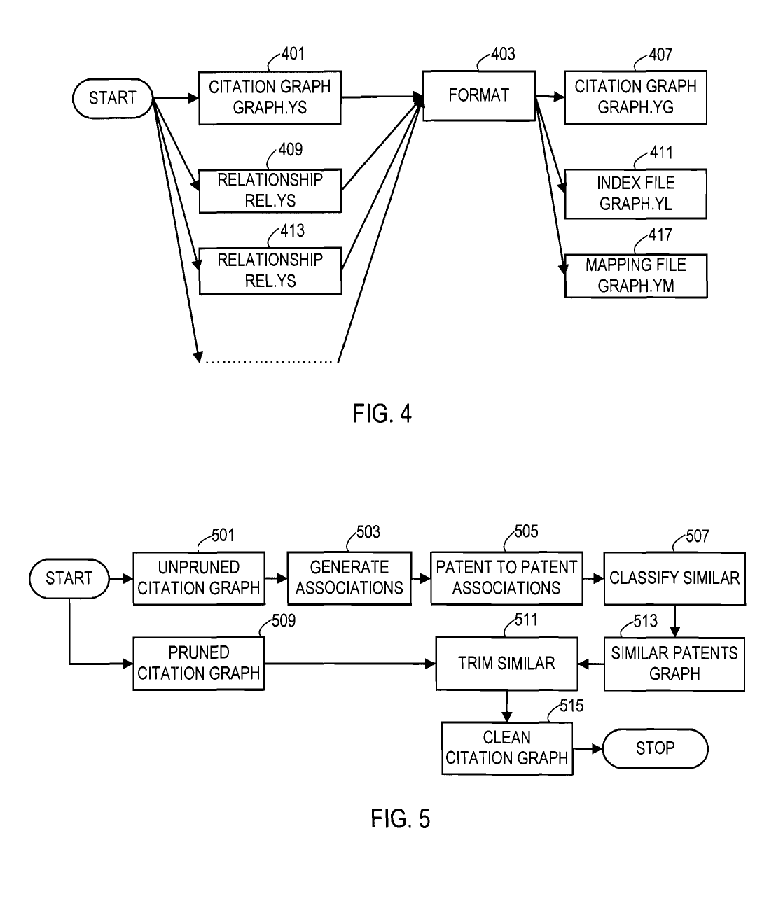

Now referring to the flow chart of FIG. 3, the clustering process 300, including steps 301-363 as shown (corresponding to individual processes shown in following FIGS. 4-35) can proceed using a number of techniques, particularly across a document set as rich as a patent collection. In one of more embodiments, the present system treats the patent universe as a large graph, with the patents the nodes and citations being directed edges between them. Once in this framework, the problem reduces to finding parts of the graph with high interconnectivity. Some aspects of the material contained herein are based on D. Gibson, R. Kumar, and A. Tomkins, “Discovering Large Dense Subgraphs in Massive Graphs.” Proc. 31st VLDB Conference, pages 721-732, 2005, which is incorporated herein by reference in its entirety.

An important tool of the present system is the ability to take a “fingerprint” of a piece of data and match it to all other pieces of data with the same signature. This reduces the computational complexity of comparing nodes from a full n<sup>2</sub> task down to a task of counting in the space of however many fingerprints it is desired to take.

Numerous patents also have spurious citations, and some companies have taken to filing them overly frequently and generating them by simply copying/pasting the citations from a previous application. The presence of these spam signals tends to over-aggregate patents into useless clusters. There are at least two ways of eliminating this, with the first being to remove citations that occur between two patents sharing a specific relationship (same assignee, inventor, examiner, of legal representation), and by classifying patents which have an unjustifiably large number of citations in common. Once removed, the signals that remain are highly specific and reasonably sensitive.

Given a set of fingerprints and the patents which contain them, those fingerprints can be grouped together in a variety of ways. One such was is by merging shingles whose generating patent sets are similar enough to overcome a threshold.

The clusters that result from very specific citation signatures tend to be highly concentrated around very specific technologies. Such a low-level separation does not always map to intuitions of an end user regarding how technologies are grouped. Since many people are accustomed to looking at technologies at a relatively high level, merging is performed based on the patent sets in clusters, to create a hierarchy of clusters and of component technologies. As a comparison of the merging process and how clusters are formed, both use thresholds and both are making Jaccard set similarity comparisons. However, these processes do remain distinct, since in the clustering step, the system merges a query shingle into a cluster by comparing the query to the individual shingles that comprise the cluster. If any one of the comparisons is above the threshold, the two are merged. If the system is comparing a shingle that is already part of a cluster to some other cluster, the system then merges the entire structures based on the similarity of just the one shingle. This is meant to be a relatively coarse step, which aggregates signals that are so strongly related that they almost trivially co-occur. Because the size of these fingerprints is small, conceptually near-identical patents can possibly share numerous such fingerprints. The creation of a hierarchy produces interesting intermediate results. Each merging step creates a new cluster comprised of the union of its two constituents, which then takes their place. Here, the system compares the full sets to one another, rather than just comparing their individual signals.

End users are provided with an “intelligent” cross section through the data, which should be meaningful. Labeling uses a hierarchy, and it can be driven from specific bands of merging parameters.

To connect patents to other patents, the system takes an n-step probabilistic transitive closure of the graph using a random-walk model. In essence, for each patent, the system “rolls a die” which determines how many steps outward, via backward citations, the system will go (e.g. 0 to 3). Given how far the system is going, it records the probability that the patent will end up on any other node. Typically, the horizon is pretty small, although it clearly gets very large, very quickly. Summing over this probabilistic space between 0 and 3 steps provides the likelihood of stumbling from one patent to any other patent, and thus a means to produce more connections in the graph.

“Core patents” are those which directly contain the signal responsible for the generation of a cluster. In the above process, such core patents those that are pushed around, merged together, sliced, and eventually used for labeling. Since these patents actually contain the signals in the cluster, they are assumed to be the most indicative of that concepts of that cluster. However, “core patents” do not fully encompass the entire patent graph. Too many patents are either malformed or contain signals too similar to spam to be trusted. To overcome this, the system uses the closure graph described above, to connect any patent to any other, and to determine the likelihood of starting at a patent and ending in any cluster. This tends to more fully populate the clusters with data from across the patent graph, which end users want to see—even if many of those patents are of dubious quality.

The system uses the above-mentioned closure graph and the concept of core clusters to determine how close clusters are to one another. For example, starting at one and picking any patent at random, the probability of randomly walking to any other cluster can be computed once that distribution is pre-computed.

The update process typically includes the following steps: formatting, updating the closure, and connecting patents. However, it is useful to incorporate changes into the citation graph for the reference of future patents that cite those documents. Ideally, the new citations would go through the same spam classification as the rest of the citation graph. If this is undesirable, however, the new patents can simply be appended at the end of the old citation graph, as is detailed on the update example page. Re-running with a full classification simply requires creating hold out copies of update graphs, but appending to the respective originals both an untrimmed citation graph and also one with trivial relationships removed. The procedure then progresses as previously described, but it stops before shingling, and the updated citation graphs are then used to drive the update of the closure graph. There is a chance that a new patent will be recognized as a spam-like copy of one that existed prior to the update which was not considered spam, and this change will not propagate to the closure graph. Simply regenerating the closure graph from scratch can perfect this. The affects of the newly classified spam patent only progress as far as the full process is re-run (i.e. it also affects clustering). Practically, keeping a spam patent in the closure graph is a relatively small issue, since its probabilistic influence is relatively poor.

### Format

Now referring to the flow chart 400 of FIG. 4, formatting is the conversion to and from human readable to binary file representations. A mapping takes place to guarantee that identifiers are consecutive and not dependent on stray characters (e.g. U.S. Pat. No. 4,938,294 or JP382958). Data is re-indexed and mapped into a highly compact binary representation tied very closely to the machine. One choice point is: in which relationships to incorporate. More specifically it is in how the formatting should handle knowledge of the connections between patents beyond their citations. These relationships include having a common assignee, lawyer, patent examiner, and inventor.

Formatting in the presence of these relationships simply performs a cut operation when it notices a patent citing to another share of any of the above. Instead, the citation and propagating diminished probabilistic influence can be down-weighted. Only the assignee and examiner data are presently available.

Two formatting commands exist, one taking a set of source files and creating the trio above, and the other doing the inverse mapping and going from a graph and mapping file to a human readable source file. These are sourceformat to format a source file, and graphformat to format a graph file.

The forward formatting permits the pruning of edges, and while it is believed that those edges do not contain meaningful cluster information, they may however contain information relevant to the discovery of “spam” patents. Typically, two formatted are generated for any citation graph, with one pruning the edges based on shared relationships and where contains every edge exactly as it was specified.

For the forward process, the input is a Source file, as described below, as well as any relationships to be incorporated, also specified as Source files. The reverse requires a Graph file and available by name a corresponding Map file.

For the format operation as shown by the flow chart of FIG. 4, the three binary files as listed below are the outputs. The graph file has the following operations done on it, by default, after its generation, including: renaming nodes linearly (canonization), sorting lexicographically, the elimination of duplicate edges, and the pruning of patents with only citation. The backwards format produces a standard Source file.

For the Source file, the input is of source type, and the three files that are created (through 403) include the graph file 407, an index file 411, and a mapping file 417. Formatting takes one “source” graph file 401 and zero or many “source” relationship files 409,413.

The format for each source file is a whitespace separated set of columns:
Column1 Column2 [Weight]

The syntax of Column1 Column2 is to imply that there is a directed relationship between Column1 and Column2, such as, “cites”, “is assigned to” etc. The weight parameter is optional. The token separators are any whitespace character or commas. For reference, the following is the C extended regular expression used in parsing:

̂([̂[:space:],]+)[[:space:],]([̂[:space:],]+)[[:space:],]*([[:digital:].]*)?[[:space:],]*$
This columnar format is officially dubbed an “edge list” representation, distinct from a “vertex list” or “adjacency matrix”. A vertex list is a slightly more compact representation, but it is less efficient for edge iteration, while an adjacency matrix would be too big for present purposes.

Source files have the suffix .ys (see e.g. blocks 401, 409, 413). These are ASCII text files and are human readable.

Now referring to the graph file, it is simply a binary representation of the source file and has a near identical format; as implied above, all of the patent identifiers from the source file and mapped to identifiers starting at 0. For example:
3914370 2276691
3914370 2697854
3914370 2757416
3914370 3374304
3914370 3436446
3914370 3437722
3923573 2154333
3923573 3337384
   becomes
0x0000000000000000 0x0000000000000001 0x3FF0000000000000
0x0000000000000000 0x0000000000000002 0x3FF0000000000000
0x0000000000000000 0x0000000000000003 0x3FF0000000000000
0x0000000000000000 0x0000000000000004 0x3FF0000000000000
0x0000000000000000 0x0000000000000005 0x3FF000000600000
0x0000000000000000 0x0000000000000006 0x3FF0000000000000
0x0000000000000007 0x0000000000000008 0x3FF0000000000000
0x0000000000000007 0x0000000000000009 0x3FF0000000000000
   where 0x signifies that the following is in hexadecimal. Also note that while the above is in little-endian, the Intel architectures of the present system are not. Graph files have the suffix .yg (e.g. 407, FIG. 4). These are binary files and machine native.

Now referring to Index Files, index files provide a level of indirection into the graph file so that the graph can be efficiently traversed. Edge list representations do not typically have a simple way to walk from node to node, as each node can be positioned anywhere in the file depending on both its identifier and how many edges were in the nodes preceding it. The index file simply stores the index of looking for each node based on its identifier, such that indexing into the file at the identifier of a given node returns the index of the edges of that node in the original graph file. Consequently, the index file is simply a long list of integers, each one either referencing an invalid address for nodes referenced in the graph but lacking their own out edges, or referencing an array index.

As an example, the following citation graph would generate the corresponding index file:
3914370 2276691
3914370 2697854
3914370 2757416
3914370 3374304
3914370 3436446
3914370 3437722
3923573 2154333
3923573 3337384
   becomes
0x0000000000000000
0xFFFFFFFFFFFFFFFF
0xFFFFFFFFFFFFFFFF
0xFFFFFFFFFFFFFFFF
0xFFFFFFFFFFFFFFFF
0xFFFFFFFFFFFFFFFF
0xFFFFFFFFFFFFFFFF
0x0000000000000006
0xFFFFFFFFFFFFFFFF
0xFFFFFFFFFFFFFFFF
   where the max number (all Fs) is taken as invalid. Index files have the suffix .yi (e.g. 411, FIG. 4). These are binary files and machine native.

With regard to the Mapping File 417, once again, the key to this file is taking the identifier given to a node and using it as an index into a file to retrieve an attribute. Here, the mapping is back to the original node names, specifically the patent or article identifiers. If the identifiers are capped at 32 characters long (including a terminating \0 to maintain C compatibility), each node, whether or not it has citations of its own, has a 32 byte entry in the file and names can be retrieved by taking 32*the node's index.

For example, if the following were at the beginning of the source file:
3914370 2276691
3914370 2697854
3914370 2757416
3914370 3374304
3914370 3436446
3914370 3437722
3923573 2154333
3923573 3337384
   The following map file would be made:
3914370 . . .
2276691 . . .
2697854 . . .
2757416 . . .
3374304 . . .
3436446 . . .
3437722 . . .
3923573 . . .
2154333 . . .
3337384 . . .
   Mapping files have the suffix .ym (e.g. 417, FIG. 4). These files are potentially human readable.

### Classifying Similar Patents

Now referring to the flow chart of FIG. 5, the similarity process uses a classifier on pairs of patents to decide if the two are above a threshold, and if so the patents are believed to be “spam” and are eliminated from further contributing to the clustering.

The similarity, command gives a classifier, at 507, on pairs of patents that produces a graph 513 of every pair of patents which is above the threshold. The trimsimilar command, at 511, takes a given a citation graph 509 and a similarity graph 513 and rewrites it without the nodes that are, contained in edges from the similarity graph 513. A citation graph file, clean citation graph 515, is the input, and the output is a smaller citation graph file.

As background, because the system typically splits the data into a graph without ‘trivial’ relationships (pruned citations graph 509, e.g. citations between patents with the same assignee or examiner), and the original, un-pruned graph 501, the system runs the similarity analysis on the un-modified graph 501, with the process shown as continuing to “generate associations 503”, and then runs its output against the pruned graph 509 to produce an even more concise citation graph. This is not necessary, however, since it is possible to remove the similar nodes from any graph consistent in identifiers.

There are three important functions which are used in classifying patents, one to map the size of a pair of patents to between 0 and 1, one to quantify the similarity of their citation sets between 0 and 1, and a final function which draws a threshold line through this space.

To map the size of a pair of patents, the system looks at their distance from the average size of patents, namely 14 citations. Where |C(n)| is the size of the citation set of node n:

Size(n1,n2)=max(0,1-28/(∥C(n1)∥+∥C(n2)∥))

So that if a pair of nodes has less citations than the average, the size is 0. Set similarity is defined using the Jaccard metric:

Similarity(n1,n2)=∥Intersection(C(n1),C(n2))∥/∥Union(C(n1),C(n2))∥

and to combine the two, the system generates two data points in the space to fit to a regression model. At a size of 50, two patents would have to have a similarity score of 0.95 to be considered spam while at size 700 a similarity of 0.1 is sufficient. A degree 5 polynomial fitting these two points is:

y=1.0174+0.4228x+0.0008528x2−0.2969x3−0.5053x4−0.6495x5

such that if the similarity for two nodes is greater than the y generated by their size value x they are considered spam. For reference, based on those the graph a similarity of 1 is required for a shared size of 45.

### Trim Commonly Cited Patents

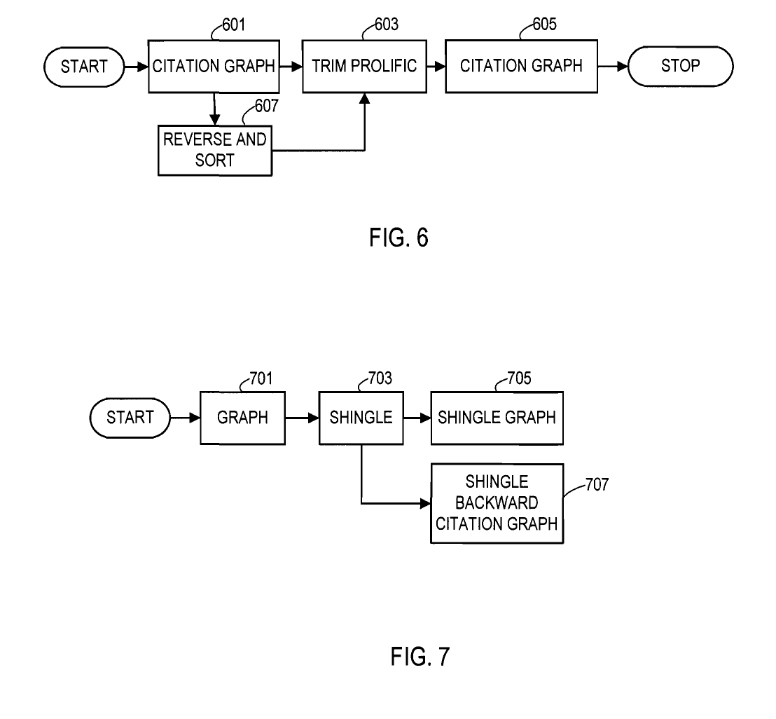

Now referring to the flow chart of FIG. 6, this; process removes patents which are cited an excessive number of times. The command trimprolific (e.g. step 603) applies to this process.

For input, it requires a citation graph 601 and its reversed, sorted form, at 607. Also, it takes a parameter listing the maximum number of times a patent can be cited to still be considered meaningful. Typical values include 140. A hew citation file 605 is the output.

As background, the main theory is that if a patent receives too many citations, those claimed relationships cannot be particularly meaningful. Increasing this number runs the risk of generating more meaningless shingles, while decreasing it cuts out the impact that some patents may well simply have within their domain (i.e. some domains are large enough that 140 or more patents citing one specific one all actually share that relationship). Arguably, even if they all share that one relationship, related patents should share relationships beyond the most popular ones.

### Fingerprint/Shingle

Now referring to the flow chart of FIG. 7, the shingling process is an iteration across the edges of a graph which produces discrete “shingles”, aka fingerprints from observations based on the edges in that graph. The system stores the shingles along with the patents which “generate” them in one file, and then in another the backward cited patents which the generating set all had in common.

The shingle command applies to this process. As an input, shingling, at 703, requires a lexicographically sorted input graph file 701. It outputs two files, one 705 containing shingles and their generating patents, and another 707 having shingles and their composing backward citations.

A byproduct of random sampling is that duplicate edges can be introduced into the shingling file. Additionally, there are many shingles which only get generated once and are subsequently dropped. As such, post-processing done by the shingle program includes sorting, elimination of duplicate edges, and the removal of shingles only being generated by a single patent. Typical post-processing involves trimming shingles of unusual size, typically too small and too large.

Once pruning is done, renaming is necessary for clustering and should happen at this step. Eventually, the backward citation graph 707 is in the exact same order with the exact same number of nodes as the shingle file, and it too must be renamed. Afterwards, the input to creating shingle associations requires a reversed and sorted shingle file.

As background, given a node N, a shingle is an ordered tuple of S out-edges from N, where S is between 1 and the number of edges in N. As an example, the node:
p1->p2
p1->p3
p1->p4
p1->p5
   can generate the following shingles of size S=2:
p2, p3->p1
p2, p4->p1
p2, p5->p1
p3, p4->p1
p3, p5->p1
p4, p5->p1

The size of the set of all possible shingles a node N can generate for a fixed size S is given by the Binomial Coefficient of n and k where n is the size of the out-edge set of N, i.e.-|E(N)|- and k is S. This is also the common “choose” function, and it is given by:

nCk=n!/(k!*(n−k)!)

Thus, the size of the full set of shingles possible is given by:

Sum(k={1 . . . n},(nCk))

This function grows as kn^{k} therefore a limit can be put on S. When applied to the patent citation network, S=2 has been chosen, since the space for S>2 can be prohibitively large and S=1 lacks sufficient specificity.

To compare nodes via shingles of different size, we compute the conditional probability of a shingle given the probability of its size. For example, the probability S=1 is (N/Sum(k={1 . . . n}, (n C k))), while the probability for S=2 is given by (N!/(2*(N−2)!))/Sum(k={1 . . . n}, (n C k)).

Subsequent trimming of the shingle file is relatively extensive. The system tends to remove shingles with generating patent sets of size less than or equal to 3 and greater than or equal to 31. The intuition is that if a fingerprint is claimed by too many or too few patents, it is not a good differentiating signal. Size 30 is chosen arbitrarily. Because of the function used in clustering, increasing the number will not drastically increase the number or size of clusters in the immediate output, but the effect can easily propagate upward in the hierarchy creation process, to create “mega” clusters. In effect, the system is designed to create the smallest possible clusters out of the clustering algorithms, and this step directly influences that.

The system also trims the shingle association file, although it only removes shingle pairs with a co-occurrence count of less than or equal to 3. If these were to remain, the system would have to compare hear an order of magnitude more shingle pairs, and the resulting cluster is considered top small to be meaningful.

With respect to terminology, to keep ah understanding rooted in the problem domain, it helps to use precise terms. Referring to the output of the shingling step simply as “shingles” can be deceptive. As shown above, a shingle is actually a set of citations made by specific patents. However, the process of shingling a node does not necessarily benefit from maintaining the association between the three patents involved. Indeed, it is necessary to do a rewrite: “p2, p3→p1” as “s1→p1” in the compact format of the original graph.

Given a shingle, the system can determine what patents were responsible for creating it. This is the same question as which patents all contain a particular pair of citations, and the function is called the “generating patent set” for a shingle, which may occasionally be written as the function P(s). Equivalently, the inverse mapping also makes sense. The shingle set generated by a patent is given by S(p). The term “fingerprint” can have more relevance and is recommended for adoption.

The system may be designed to capture perfect shingling information for every node. Unfortunately, as |E(N)| increases, the number of shingles of size 2 grows with the square of the input. Therefore, in the case of |E(N)| being larger than some threshold, there is a fall back to randomly sampling shingles from the out edges of N. Sampling occurs with replacement, so duplicate shingles are generated. Additionally, the number of random samples to take is a function only of the threshold size, not the number of out edges of a node. In an ideal function, the system would resample until it had generated enough samples that the expected number of was at the threshold, and that the threshold would increase at some small rate proportional to the input size. In essence, given a threshold of 40 edges, a node with 60 out edges should generate the same number of shingles as one with 50, both which are potentially less than one with 40.

### Cluster

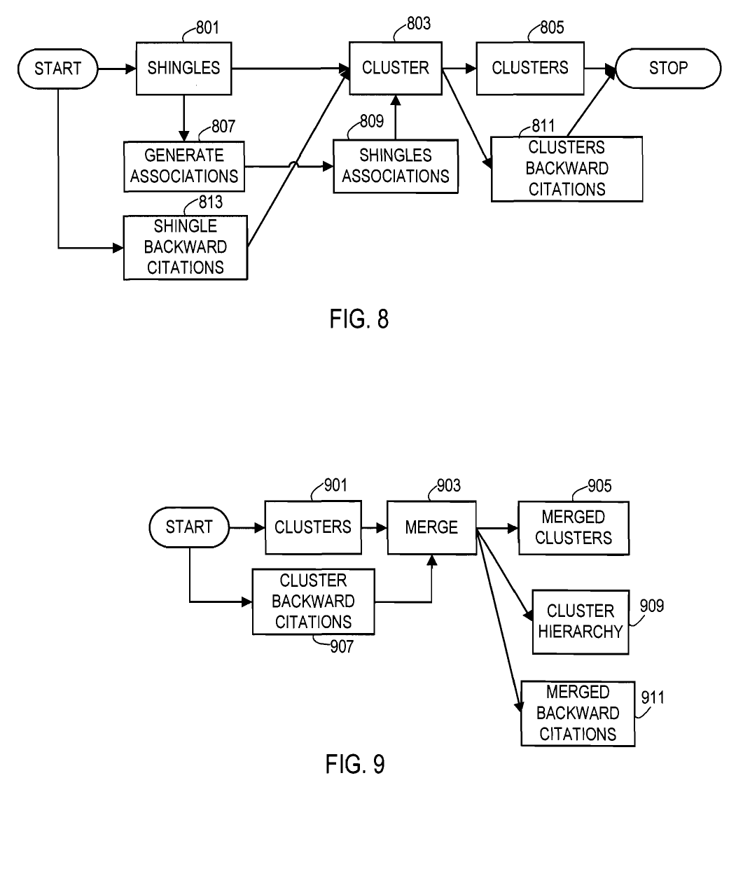

Now referring to the flowchart of FIG. 8, the Cluster process takes the shingling data and the shingle pair associations and groups together shingles with a high degree of co-occurrence (as haying a high weight in the associations file), and into a set of shingles standing, which then stands in for each one. The clusters are then recovered by looking up the generating patent set of each shingle in each set of shingles. For each cluster it creates, it tracks which backward citations those patents made which were responsible for them being grouped together. This is activated using the cluster command.

With regard to inputs, as stated, this process requires a shingle file 801 and an explosion file, both of which must be sorted lexicographically. A third file of shingle backward citations 813 is necessary to preserve that information. Finally, a similarity threshold can be provided as a way of controlling how similar shingles should be to be merged. With regard to outputs, as each patent can occur many times in a cluster, there are a significant number of repeated edges in the resulting graph file. The cluster program sorts and merges its outputs and does the same for the cluster backward citation file 811. A typical post-processing step is to sort the cluster file based on node size, reorder the backward citations file to match, trim subsets, and then take the intersection of the now-reduced cluster file with its backward citations. If there are a lot of small clusters at the outset, trimming them before looking at subsets will provide a substantial time savings, as long as those are eliminated from the backward citation file, as well.

As background, shingles appearing together in the shingle associations file 809 are grouped together to form a cluster 803. Pruning that file directly influences what clusters get generated, at 805. Clusters always increase in size, and will blindly merge with other clusters if they share a single common shingle whose generating patent sets have a similarity above the threshold. A typical value for this threshold is 0.66. As an example:
s1 ? s2: 0.9
s1 ? s3: 0.9
s3 ? s4: 0.9
   will generate a single cluster consisting of s1, s2, s3, and s4.

Increasing the value makes the initial clusters smaller and more precise, although at some point they simply fail to merge effectively, thanks to the system's similarity function. Consider that two shingles with generating patent sets of size 5, with an intersection of 4, have a Jaccard set similarity of ⅔. They will merge at 0.66, but smaller things will not. Even comparing 5 to size 6 with an overlap of 4 fails. Lowering the threshold tends to create overly large starting clusters as it becomes too easy for stray shingles to achieve sufficient similarity with any one other shingle.

It is worth observing that this is simply an input to a proper merging procedure, and basically nudges the ordeal along to the point of recording the merge steps. In terms of the second step, the less merging that takes place at this point, i.e. the more clusters in the result, the more expensive the comparisons and memory allocation in the hierarchy creation step.

The clustering process is the first that requires significant amounts of memory, on the order of a few bytes for every shingle. Because of random access in merging sets, if the number of shingles is too large, this step can stall on disk i/o. There may be ways to better linearize and parallelize the merging operations to avoid this, adding sufficient RAM seems to provide a solution.

### Merge

Now referring to the flow chart of FIG. 9, the merging process takes a base level set of clusters and progressively combines the two most similar, creating a hierarchy of clusters. As it does so, it outputs for each merged cluster the set of patents it contains and the backward citations responsible for the new, merged cluster. In addition, a graph file representing the merged hierarchy is created. The mergeclusters is used for this process.

The input is a sorted, renamed cluster file 901, and an equivalent sorted, renamed backward citation file 907. If the cluster files are not renamed, an excessively large amount of memory is used. An example similarity threshold value is 0.29999.

The outputs are three graph files: a merge file 905 consisting of all possible merges for the given threshold, the backward citations 911 for every merged cluster, and a hierarchy 909 expressing the relationships between those merged clusters. By outputting all possible merges, this makes it trivial to recover any step in a merge without having to go down to the bottom of the graph and rebuild it.

As background, as the clustering merges shingles based on a similarity in their generating patent sets, many more clusters are produced of varying size, albeit much smaller size. To clean this up, the system merges similar clusters. This also has the added benefit of creating a hierarchy of clusters as they are merged, which can allow one drill down through clusters with greater specificity.

The similarity function used is:

Similarity(n1,n2)=(∥Intersection(C(n1),C(n2))∥/min(∥C(n1)∥,∥C(n2)∥))1.0001̂|∥C(n1)∥−∥C(n2)|∥

This function, dubbed the “Magic” similarity function, decays with the absolute value of the difference in the size of the citation sets. If the two sets are equally sized, the function is equivalent to the size of the intersection of the size of any one of the sets. As the comparison becomes more asymmetric, the similarity function slowly approaches zero. It is based on a min-set overlap function:

Similarity(n1,n2)=∥Intersection(C(n1),C(n2))∥/min(∥C(n1),C(n2)∥)

The threshold of 0.3 was chosen empirically. Decreasing this value makes the system generate fewer clusters, all of which are smaller.

With regard to limitations and complexity, the size of the set of clusters should be much smaller than that of the patent space. Regardless, O(n2) time and space are necessary. That is to say, space is a consideration, since the system has to compute the similarities between all clusters. Implementation realizes that for the most part, clusters are disjoint and that the similarities form a sparse graph, and thus for a cluster the system only needs to keep a list of the other clusters to which it is similar. In an exemplary implementation, a matrix was used to store similarities, but the memory required by the upper triangle of 75,000 clusters was prohibitive.

Updating after a merge involves taking every node in the similarity set for each of the child clusters and updating their distance to a new, bigger cluster. In addition, it is necessary to minimize the amount of memory allocation necessary, maintaining a union-find data structure across all nodes at start and redirecting to the merged node as the system proceeds, so that the system can reuse the original array.

### Slice

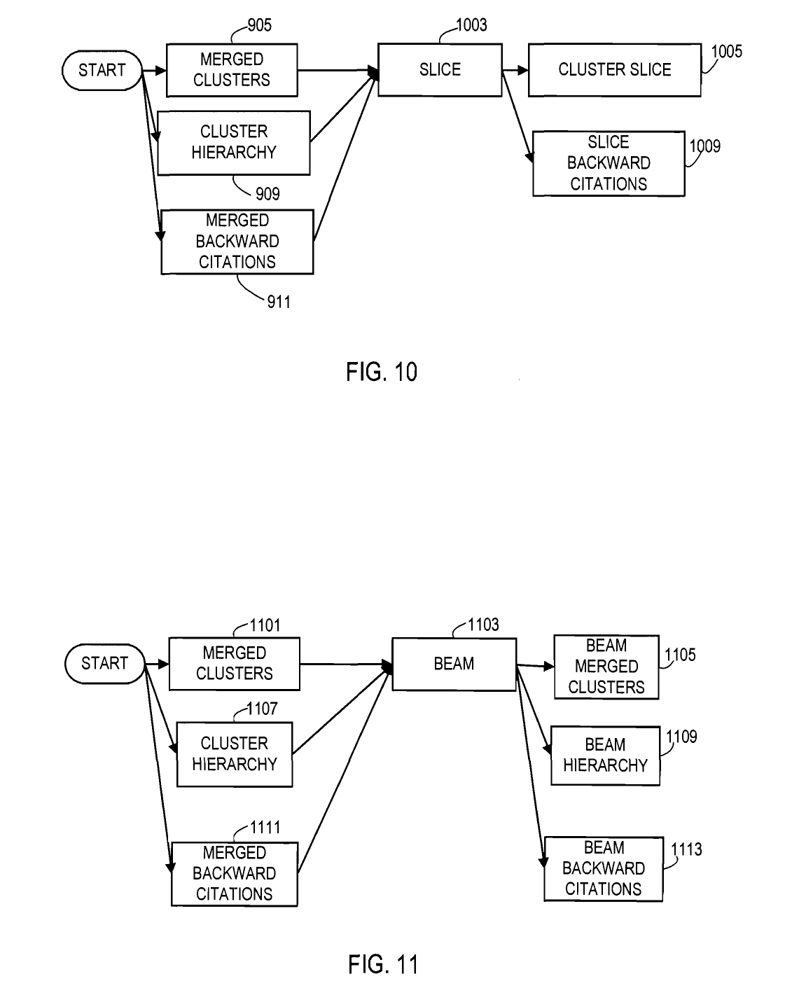

Now referring to the flow chart of FIG. 10, the Slice process (see slice at 1003) cuts a cross section at a specific threshold out of a hierarchy for use in the visualization tool. It works in a top down approach, starting at the root of the hierarchy and walking down until it hits the bottom of finds a merge step which is below the threshold. The slicemerge command is used for this process.

Referring now to FIG. 9, also, the inputs 905,909,911 are directly the outputs of the merge process and a specific threshold. Some example values are 0.3, i.e. the top of the typical merge. The outputs are a cluster file 1005 and a cluster backward citations file 1009. These are typically the inputs to the connect clusters and connect patents processes.

As background, as mentioned above, slicing works in a top down approach. It is worth noting that the beam process works in a bottom up fashion, and that the two may not always extract the same clusters for the given threshold, since as the system progressively merges upward, it can create clusters having a higher similarity to some other cluster than that of the step which was just taken. When going down from the top, the system may stop above this step, while from the bottom the system would capture below it.

### Beam

Now referring to the flow chart of FIG. 11, Beam cuts a band between specific thresholds out of a hierarchy for use in cluster labeling. It works in a bottom up approach, starting at the original clusters and walking up the hierarchy until it hits the root or finds a merge step which is above the threshold. Everything from the first cluster within the band, to right before the first cluster above the threshold, gets outputted.

The beammerge command is used for this process. The inputs are directly the outputs of the merge process (905, 909, 911) and a pair of thresholds. Typical example values are 0.49999 and 0.29999, i.e. right above merging sets of size 2 with one in common and the top of the typical merge. The outputs (beam merged clusters 1105, beam hierarchy 1109, and beam backwards citation 1113) are trimmed files of the same types as those from the merge process. These are typically used in labeling only.

As background, as mentioned above, beaming works in a bottom up approach. It is worth noting that the slice process (FIG. 10) works in a top down fashion, and that the two may not always extract the same clusters for the given threshold, since as the system progressively merges upward, the system can create clusters which have a higher similarity to some other cluster than that of the step which were just taken. When going down from the top, the system may stop above this step, while from the bottom the system would capture below it.

### Graph Closure

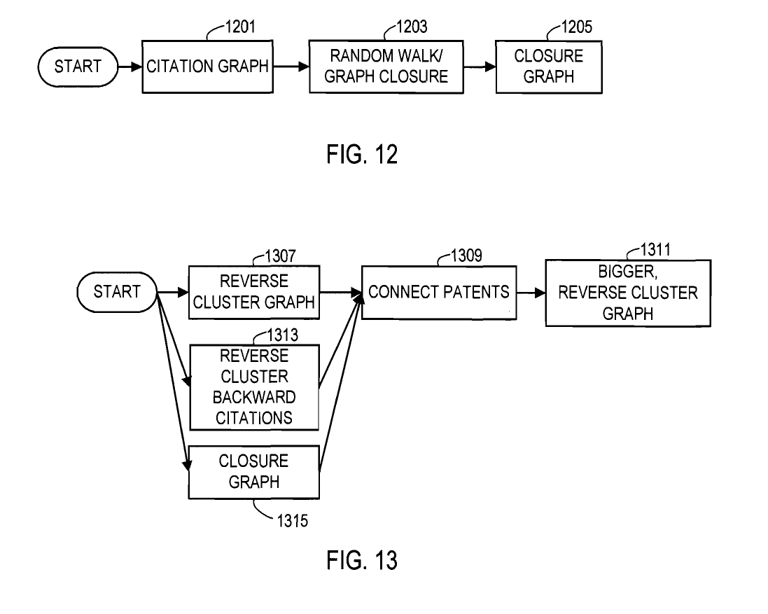

Now referring to the flow chart of FIG. 12, the Closure process employs a random walk outward (see block 1203) from each patent in a citation graph, connecting every patent to other patents within its near neighborhood. In ah exemplary embodiment, the number of hops outward is taken to be between 0 and 3, and the distribution assign uniform probability to each event.

The closure command is used for this process. The input is a formatted citation graph 1201, preferably one that has had its redundant edges pruned (i.e. ones sharing assignee, examiner, inventor, or legal relationships). Removing “spam patents” is not entirely necessary, since their probabilistic influence will likely be rather minimal. In terms of outputs, the result is a graph file 1205 which represents, for each patent, the probability of landing on a specific other patent, given a choice of walking 0 to 3 hops out of a uniform distribution.

### Connect Patents

Now referring to the flow chart of FIG. 13, the Connect Patents process uses the closure graph to associate patents to clusters based on the probability of walking from that patent and landing in a cluster or on a backward citation for a cluster. This is mainly used to associate non-core patents to clusters. It also associates core patents to clusters that could have been missed in the merging step.

The connectpatents command (see 1309) is used for this process. For inputs, it requires reversed, sorted, and indexed cluster 1307 and cluster backward citation graphs 1313, and a closure graph 1315. The output is a cluster file 1311, in the reverse of the format, but retaining the IDs of the input, with the unintuitive edge weights relating patents to clusters being replaced by probabilities. Typically, it is trimmed based on edge weight, while preserving at least one edge for each patent (trim by size within node). After trimming, reverse and sort occur, and then this process is complete.

As background, this process uses the backward citation graph as a possible point of connection between patents and a cluster, but it prohibits backward citations from associating with a cluster by identity. In essence, if a backward citation is in the final cluster, it was already part of the original cluster.

### Connect Clusters

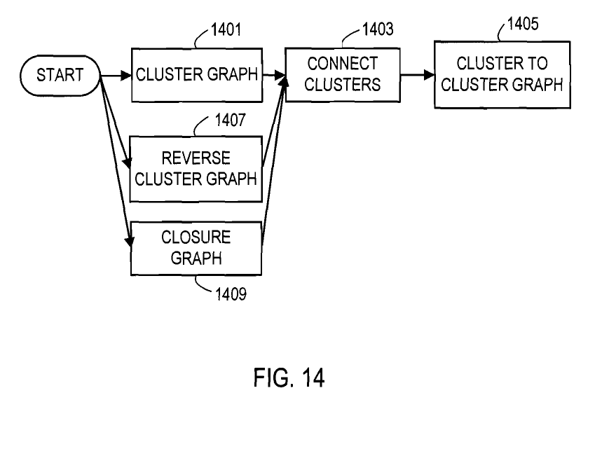

Now referring to the flow chart of FIG. 14, the Connect Clusters process uses the closure graph to estimate the distance from any one clusters to any other based on the probability of walking from that cluster and landing on some other cluster. The connectclusters command (see 1403) is used for this process.

For inputs, it requires a sorted and indexed cluster graph 1401 and a reversed, sorted, and indexed cluster graph 1407, and a closure graph 1409. Also, a minimum number of connections is needed to preserve for each cluster, every connection beyond which is only preserved if it is the backward edge from some top connections of another cluster. In an exemplary embodiment, this is run only on the “core” patent set for a cluster, but not for the patents which might connect in via Connect Patents process. The system also tends to run only on the sliced graph. The output is a cluster-to-cluster graph file 1405, asymmetric with edge weights representing the strength of the connection.

### Cluster Import

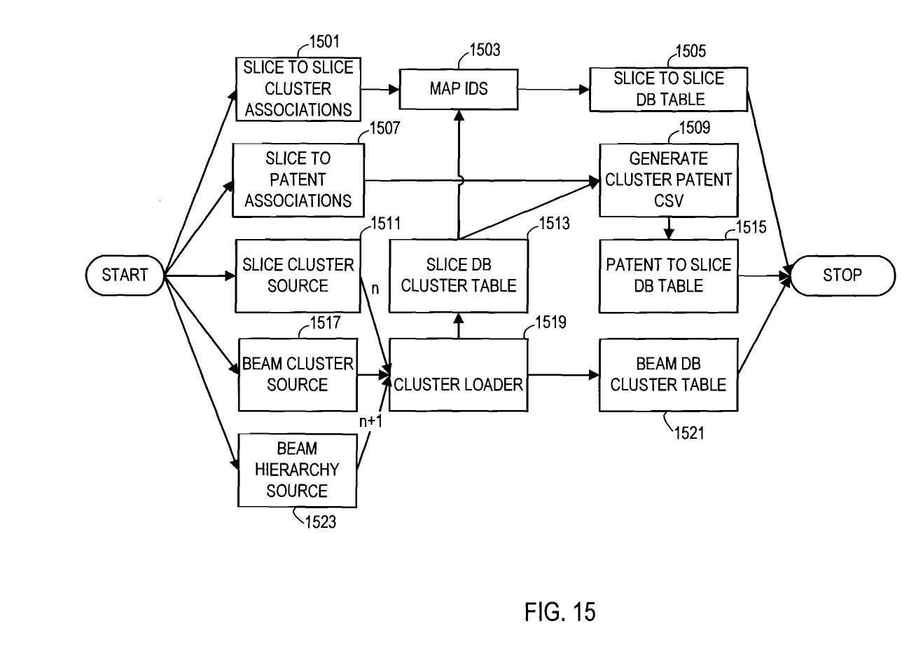

Now referring to the flow chart of FIG. 15, a few steps are necessary to populate the necessary tables with a new cluster set. The following commands are used in this process:
php cluster_loader.php clusterSourceFile [hierarchySourceFile]
php generate_cluster_csv.php clusterSourceFile databaseIdOutputFile clusterTypeId
php map_ids.php inputSourceFile databaseIdOutputFile {c|p|n} {c|p|n}[clusterTypeId]

The cluster import process is run when new cluster data is available, for example once every 6 months.

In terms of inputs, all of the following require insertion into the database: slice to patent cluster file 1507 (core or not), slice to patent (expanded) cluster file 1511, beam to patent cluster file 1517, beam hierarchy file 1523, and slice-to-slice cluster associations file 1501. Outputs are any of a number of populated database tables (1505, 1515, 1521) or CSV source files which can be painlessly inserted.

### Usage

In the Cluster Loading phase (see e.g. step 1513), the patent cluster link table is not created; instead, new rows are inserted into the cluster table so that the appropriate mappings between development cluster ids and database cluster ids occur. If there is a hierarchy available, the proper database fields are updated. Once this is available, subsequent import functions dump the entire table at the beginning of their operation to minimize hits against the database.

The Generate Cluster CSV step 1509 takes a development cluster “id ?” patent number source file and creates a “patent id ?” database clustered comma separated file for insertion into, a patent_cluster_link table. Note, the fields are separated by commas (,). The output front this can be inserted using the mysql command:
LOAD DATA LOCAL INFILE ‘/path/to/file.csv’ INTO TABLE
patent_cluster_link FIELDS TERMINATED BY ‘,’ LINES TERMINATED BY ‘n’ (patent_id, cluster_id, link_score).

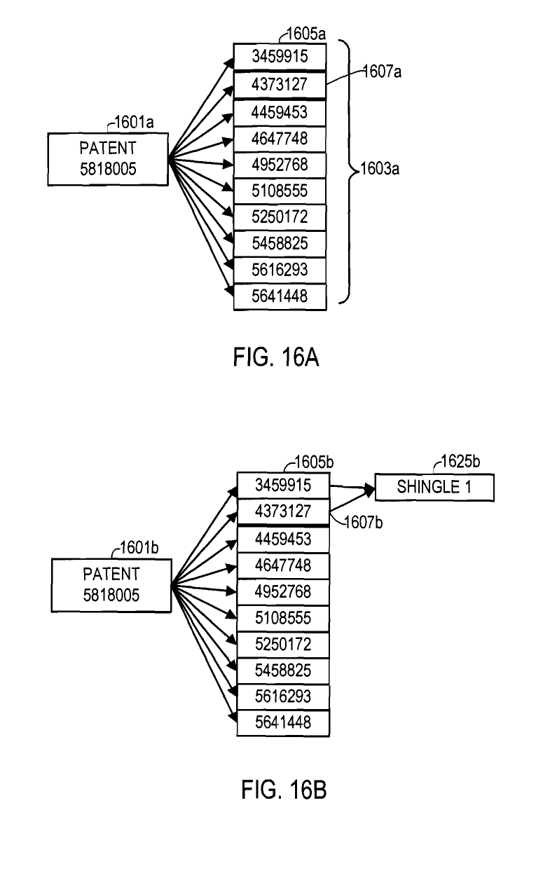

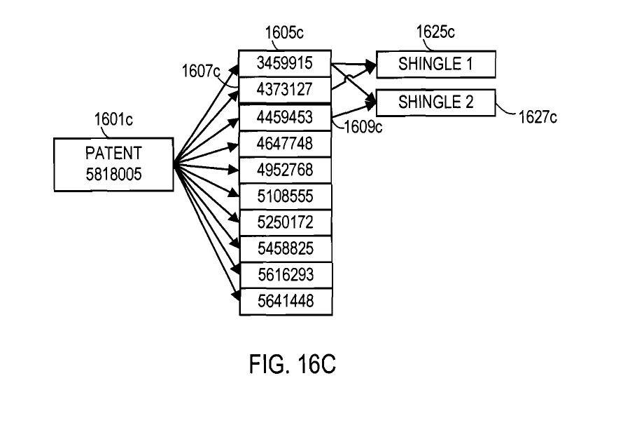

The Map ID (“map id”), process 1503 is very similar to the cluster CSV step, except that it is slightly more generic. By switching between ‘c’, ‘p’, or ‘n’, the user can specify that the first and second columns should be mapped as clusters, patents, or not at all, respectively. If either column is specified as clusters, the cluster type id must be specified. Weights are preserved as-is. Unfortunately, this only works on a three column file and maps the first two columns, so it does not apply to label files. The fields are separated by spaces, so after generating a slice to slice association file one might import it via the following:
LOAD DATA LOCAL INFILE ‘/path/to/file.txt’ INTO TABLE
cluster_to_cluster_link FIELDS TERMINATED BY ‘ ’ LINES TERMINATED BY ‘n’ (source_cluster_id, target_cluster_id, similarity_score)
   The system could easily create the patent to cluster link files using the map id script, although the Generate Cluster Csv process 1509 reverses the columns, which makes file a direct mapping to the database fields. As an example, consider the diagram in FIG. 16A of the patent 1601 and its backward citations 16703a.

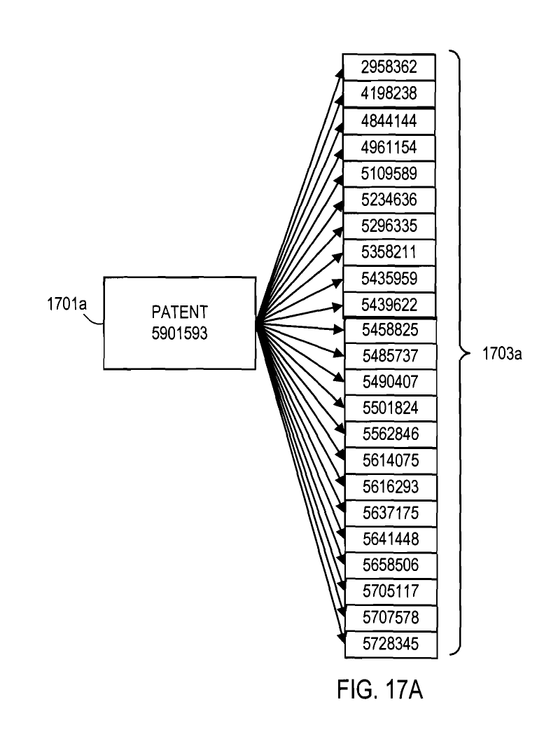

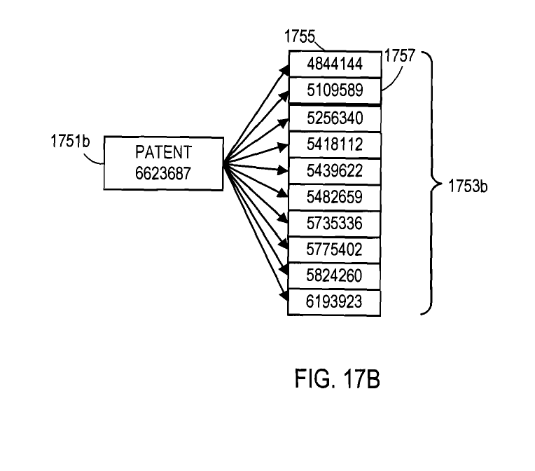

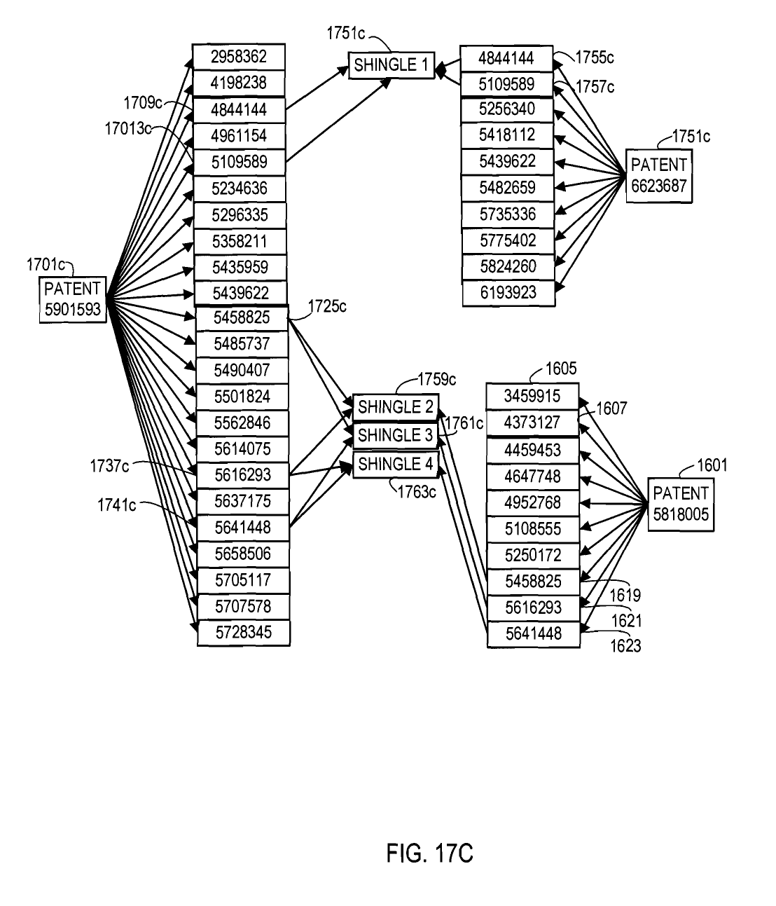

A shingle (or fingerprint) is defined as an unordered subset of size S of the relationships expressed by an entity of interest. In this example, the system is concerned with the citations of patents and the shingle size is typically limited to 2. The first two shingles 1625,1627 of U.S. Pat. No. 5,818,005 are shown in the diagrams of FIG. 16B and FIG. 16C, respectively. The co-occurrence of these shingles by different patents drives their clustering. For example, also consider the following U.S. Pat. Nos. 5,901,593 (reference numeral 1701) and 6,623,687 (reference numeral 1751) as shown in the diagrams of FIGS. 17A and 17B, respectively. As shown in the diagram of FIG. 17C, these cluster together with U.S. Pat. No. 5,818,005 (reference numeral 1601), based on their shared citation patents 1725c, 1737c, 1741c, also referred to as the shingles (1759c-1763c) they generate. However, it should be noted that more relationships exist than those shown here, via other patents.

### Cluster Naming Overview

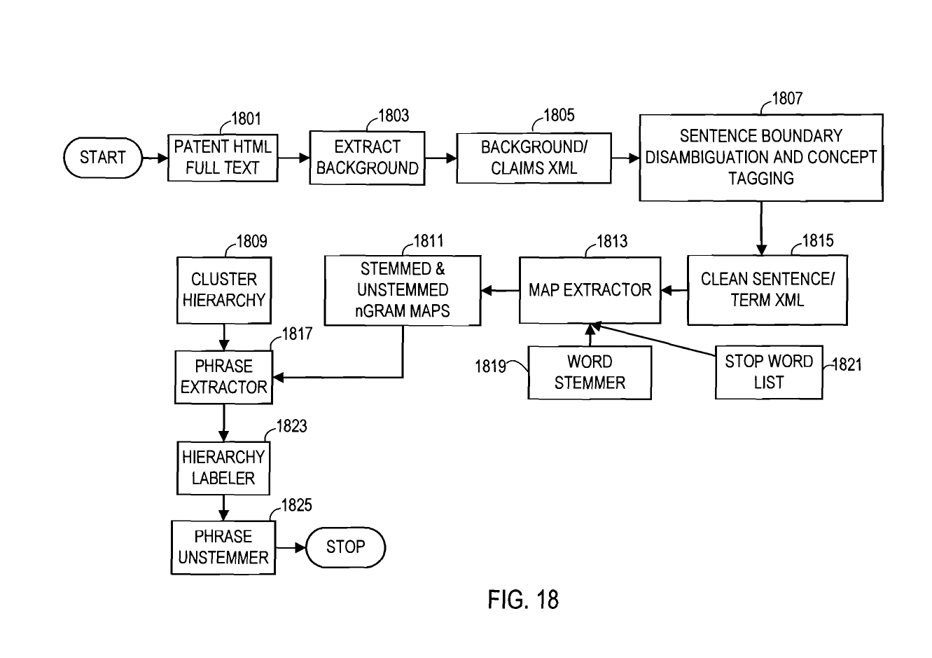

Now referring to the flow chart of FIG. 18, the problem of generating good cluster names or labels is one of “Natural Language Processing.” It is desirable to generate human-understandable cluster labels which are descriptive and unique. Unfortunately, the body, of text available to extract labels is the patents themselves, and it is quite common for two similar patents to describe the exact same concept or technology using different terminology, since each inventor or patent attorney acts as his own lexicographer.

The Background of the Invention contains a significant amount of material of a patent, and can describe the field and scope of the actual invention, typically using terms that are of the most significance and use. In contrast, the title contains less material to process, the abstract may only be tenuously linked to the invention, and the claims may only appear in legalese. Not all of the Background of the Invention section is as valuable as the rest, and also, the Detailed Description of the Invention section may include several unrelated inventive concepts. Patent full-text is not readily or currently available in structured format, so the system must use textual analysis to try to determine what text belongs in what part of the patent.

With regard to Sentence Boundary Disambiguation, at step 1807, consider any example sentence. Most typically, a sentence contains a set of ideas, hopefully related, and ends with a punctuation mark such as a period (.) exclamation mark (!), or question mark (?). Unfortunately, these marks have dual purposes in the English language. A company like Yahoo! complicates sentence boundary disambiguation greatly. Sentence boundaries are important because they give context to chains of words. While the system scans a sentence and computes metrics on the words it contains, it is assumed that each word relates in some small degree to preceding words. However, across a sentence boundary, the same assumption is relaxed. Ideally, it is desirable to identify a word at the beginning or end of a sentence as a sentence marker and with less emphasis on its relation to other words in the sentence.

With regard to Concept Tagging, at step 1807, this relates to the idea that a significant percentage of terms in a patent are highly specific and not at all conceptual. A reference to another patent or the specific constants on a formula are indicative of concrete entities, and thus they are expected to have poor utility in classifying patents on hopefully different things. They also take up a lot of space and time. To reduce, these specific terms down to actual conceptual references, a set of regular expressions is used to identify and replace them.

Stemming (step 1819) and, to a smaller degree here, synonymy are important to reducing words which have the same meaning but have different spellings. Without reducing them to their stem, the system would have to count each separately, and thus reduce the effective signal of each. Unfortunately, this presents the counter challenge of un-stemming, as well.

Now referring to Stop Words (step 1821), some words are trivial and should be ignored. The present system includes a rather lengthy compilation and includes the stringent requirement that if the system ever identifies a stop word, it cannot be part of an n-gram.

With regard to Metrics, given a set of sentences derived from the text of patents, the system must be able to analyze each phrase and compute some statistics. For now, reasonable things to ask include Term Frequency, which simply represents how many times a phrase occurred, divided by the total number of phrases. In a Frequentist probabilistic interpretation, can be assumed to give the likelihood of that phrase.

Document Frequency represents how many documents a term appeared in. In the present invention, since the system is starting with a predefined set of clusters, a good term would hopefully appear in most or all of the patents. Term Independence involves asking if the context of a phrase is random. If so, it is considered “independent”. A dependent phrase may not be long enough and would benefit from extending to include neighboring words. Zeng, H., He, Q., Chen, Zheng, C, Ma, J., “Learning to Cluster Web Search Results.” SIGIR, Jul. 25-29, 2004, which is incorporated herein by reference in its entirety, can be referred to on the motivation for this and for other potential metrics.

With regard to Maps, at steps 1811, 1813, the present system has the issue of not knowing how to combine this data until a hierarchy has been established, but to do this time and time again for each patent (which might appear in numerous clusters) would take a very long period of time. To solve this, the system pre-computes as much as possible and stores it in binary files, e.g. 1815, on disk. These have been coined as “n-gram maps,” after the special data structure, used, to reduce redundancy. A map would simply go from term → statistics object, but the system can do better, since it is known that a term is actually a phrase and is composed of words. For example, if one wanted to build a map for the two terms “optical disk” and “optical disk storage” using a traditional map, the system would build:
“optical disk”→stats
“optical disk storage”→stats
   But, that means that the system is tracking “optical disk” twice. A more compact mechanism reuses that data:
“optical”→“disk”→stats
“optical”→“disk”→“storage”→stats
   This data structure is used to efficiently create maps over the terms of a document to relevant other data structures, such as statistics or other maps.

With regard to Salient Phrases, clusters then define smaller bodies of documents from which the system wants to extract “salient phrases,” at step 1817. These are going to be phrases which score high on the above metrics. To get these for a given cluster requires reading in the maps of every patent in the cluster and then merging them. Currently, the numbers computed are mapped onto standard distributions within their own n-gram, e.g. the term frequencies for all unigrams are centered around mean 0 and standard deviation 1.

With regard to Cluster Labels, at step 1823, since the system has a hierarchy of clusters, there is a reasonable assumption of understanding of how clusters relate. Two completely unrelated clusters should never share a cluster label, while siblings on a hierarchy that both contain the same salient phrase with a high score are candidates for merging. Certainly, while walking down a hierarchy, it is desirable for each level of clusters to be more specific in its label, so that the parent takes the more general term.

With regard to Phrase Un-Stemming, at step 1825, the phrase “un-stemming” simply requires using the maps generated at stem time, which counter the frequency of the phrases, which produced the stemmed version, merging these for each patent in a cluster and making the backward association.

### Parsing HTML

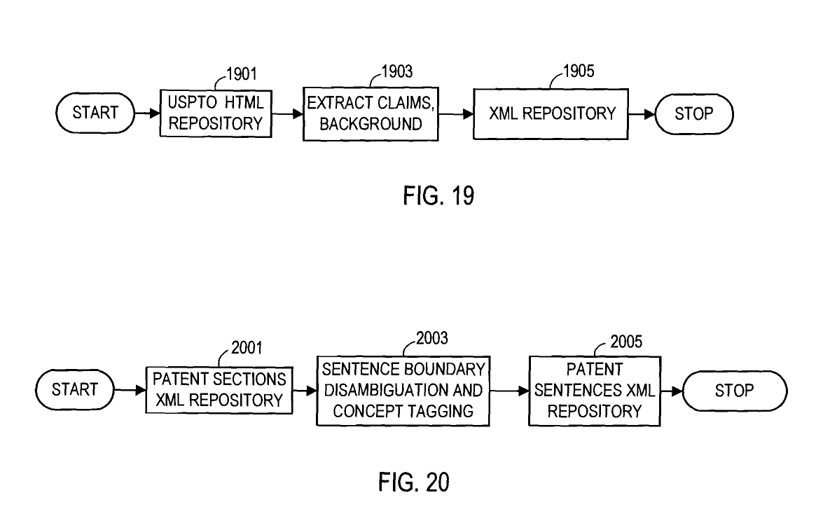

Now referring to the flow chart of FIG. 19, given a collection of patent HTML and using a series of regular expressions, the Parsing HTML process generates a corresponding XML collection (xml repository 1905) which has semantically identified independent and dependent claims as well as the individual sections of the full text description, including Field of the Invention, Summary of the Invention, Background of the Invention, Brief Description of the Drawings, and Detailed Description of the Drawings, and so on.

The command extract_text.php is used for this process. It should be run on every new HTML data acquisition. For inputs, it processes a repository in /data/patents/html (see 1901). Repositories are hashes on the first 4 digits of patent numbers, e.g. /data/patents/html/4/5/3/4/4534XXX.html. For outputs, it produces a repository in /data/patents/xml. Repositories are hashes on the first 4 digits of patent numbers, e.g. /data/patents/xml/4/5/3/4/4534XXX.xml. Its file types are HTML (the source HTML) and XML, where in the exemplary embodiment of FIG. 19, only the claims and background description sections are extracted. A full parse of all semantically-identifiable may be desirable. White space, in particular line breaks, are preserved for use in sentence extraction. Accordingly, An example document would look like:

<patent patent_number=“”>
<title></title>
<abstract></abstract>
<claims>
<claim claim_number=“”></claim>
<claim claim_number=“” parent_claim_number=“”></claim>
</claims>
<description>
<field></field>
<background></background>
<related_art></related_art>
<summary></summary>
<drawings></drawings>
<example></example>
<detail></detail>
<other></other>
</description>
</patent>

### Extracting Sentences

Now referring to the flow chart of FIG. 20, the Extracting Sentences process parses a collection of XML structured patent data (patent sections xml repository 2001) into a collection of the likely sentences as they appear in the patent. Additionally, it does some preprocessing on the terms to identify likely conceptual terms which are not informative, at step 2003 (e.g. other patent numbers, references to figures, formulae).

The ant sax command is used for this process. It should be run on every new XML data generation. For inputs 2001, it processes a repository in /srv/data/patents/xml. Repositories are hashes on the first 4 digits of patent numbers, e.g. /srv/data/patents/xml/4/5/3/4/4534XXX.xml. For outputs, it produces a repository in /srv/data/patents/sentences, at step 2005. Repositories are hashes on the first 4 digits of patent numbers, e.g./srv/data/patents/sentences/4/5/3/4/4534XXX.xml. File types are XML and Sentences, where for XML, the input is the output of parsing html process, and for Sentences, the full text, minus the example/embodiment section is broken into its likely sentences, concepts are tagged and combined, and a corresponding XML file is created.

Tags identified include references to specific elements (patents, figures), numbers, and formulae. An example document would look like:
<patent patent_number=″″>
<sentence></sentence>
</patent>

### Creating N-Gram Maps

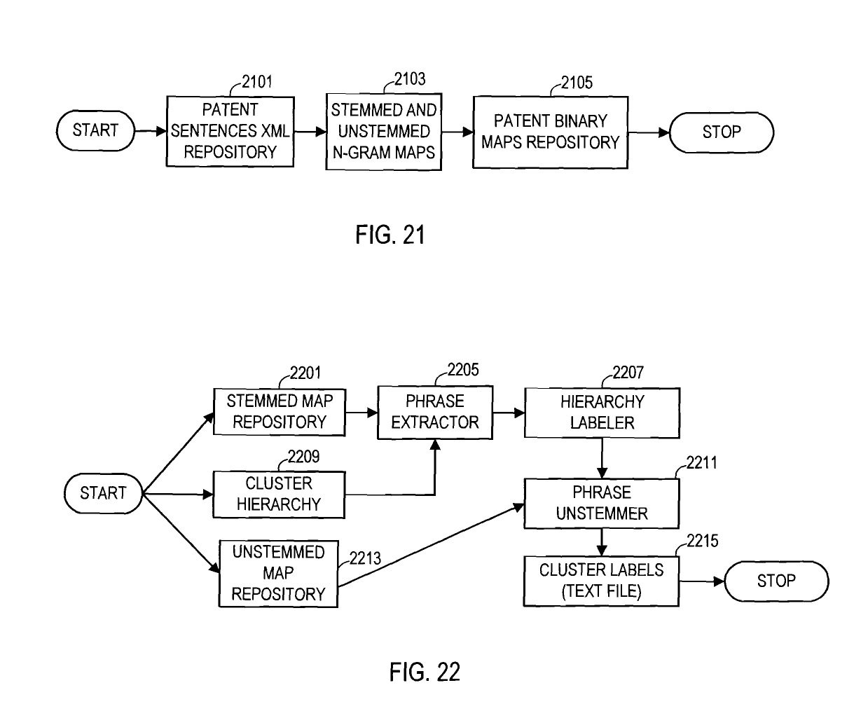

Now referring to the flow chart of FIG. 21, the Creating N-gram Maps process parses a collection of XML structured patent sentences, at step 2101 into a pair of maps 2103, one counting the occurrence of every stemmed N-Gram and containing a map of the unigrams in the left and right contexts, and another mapping every stemmed N-Gram to the counts of the occurrences of its unstemmed forms. It heavily utilizes a stop-word detector to skip uninteresting terms.

The ant counter command applies to this process. It should be run on every new XML sentence generation. For inputs, at 2101, it processes a repository in /srv/data/patents/sentences. Repositories are hashes oh the first 4 digits of patent numbers, e.g./srv/data/patents/sentences/4/5/3/4/4534XXX.xml. For outputs, it produces a repository in /srv/data/patents/counters, at 2105. Repositories are hashes on the first 4 digits of patent numbers, e.g./srv/data/patents/counters/4/5/3/4/4534XXX.bin and /srv/data/patents/counters/4/5/3/4/4534XXX_unstemmed.bin. File types are XML, where input is the output of sentence extraction process, and Maps. Maps are Java serialized files, representing tree-based maps across different sizes of N-Grams. The stemmed maps go from a string sequence to a DocumentNGramStats class, which maintains a count of the term and a counter over the unigrams appearing in each of left and right context. The unstemmed map, maps from the stemmed sequence of terms to a counter of the above type (albeit without the superfluous storage of contexts).

Every time the stop word list is updated, the set of binary files should be updated using ant update, and if the types of statistics to be computed changes, the whole set should be regenerated from scratch.

### Labeling Hierarchy

Now referring to the flow chart of FIG. 22, given a set of patent N-Gram binary maps, a cluster core patent set, and a cluster hierarchy, for each hierarchy the patents are used to generate a set of labels. The ant label command is used for this process. It is run when new cluster data is available, for example, once every 3 months. For inputs, it processes a repository in /srv/data/patents/counters, at 2201. Repositories are hashes on the first 4 digits of patent numbers, e.g. /srv/data/patents/counters/4/5/3/4/4534XXX.bin and /srv/data/patents/counters/4/5/3/4/4534XXX_unstemmed.bin, at 2213. It also requires, as parameters in the build.xml ant file, a merged, core-patent source file and a corresponding source hierarchy, at 2209. For outputs, from step 2207 hierarchy labeler and phrase unstemmer 2211, this is a simple text file, labels.txt, at 2215, which has the development cluster id as the first term on a line and the rest of the line being the unstemmed label. File types are Maps, the output of the n-gram map creation process.

Typically, the inputs are produced by the beam hierarchy process, and then formatted into YippeeIP Source files. Of key note is that there is no extra work done in connecting patents to the cluster set, in that if the initial patents in a cluster really are most representative, they should be the ones directly involved in the labeling.

As detailed above, this is actually a three step process. There is the loading of the maps for each patent which are then merged into a single map for a cluster. Once in a cluster, a score for each n-gram is computed using the following function:

0.176*tf^{0.2}*df+0.251*(length/maxLength)+0.346*independence

where tf is the term frequency of the n-gram among all n-grams its size, df is the document frequency for the same, and independence is a measure of the entropy of unigrams appearing on the sides of the query n-gram. Refer to the inspiring paper of Zeng, H., He, Q., Chen, Zheng, C., Ma, J., “Learning to Cluster Web Search Results.” SIGIR, Jul. 25-29, 2004 (cited above, incorporated herein by reference in its entirety), for more information.

Once there is a map for each cluster, the n-grams are extracted, at phrase extractor 2205, from the map and the data in memory used to generate them is destroyed due to practical constraints.

The next step 2207 is to label the hierarchy, which proceeds in a top-down, bottom-up fashion. For a given cluster, labeling is constrained to ah operation between its children and a simple consistency check between all the ancestors up to the root. The process operates as follows: First, anode picks, the first label from its list that does not overlap with its ancestors. Second, both of the children do the same. Third, if the children conflict, the one with the lower score for the term goes back to the top. That is, the system enables each node to try multiple terms, with a composite score for a cluster being the sum of the score of its label and the average score of its children's labels.

The next step is to un-stem the derived labels, at 2211. This requires loading in every un-stemming map for every patent in every cluster, merging them, and finding the most likely way to reverse the stemming operation.

### Label Import

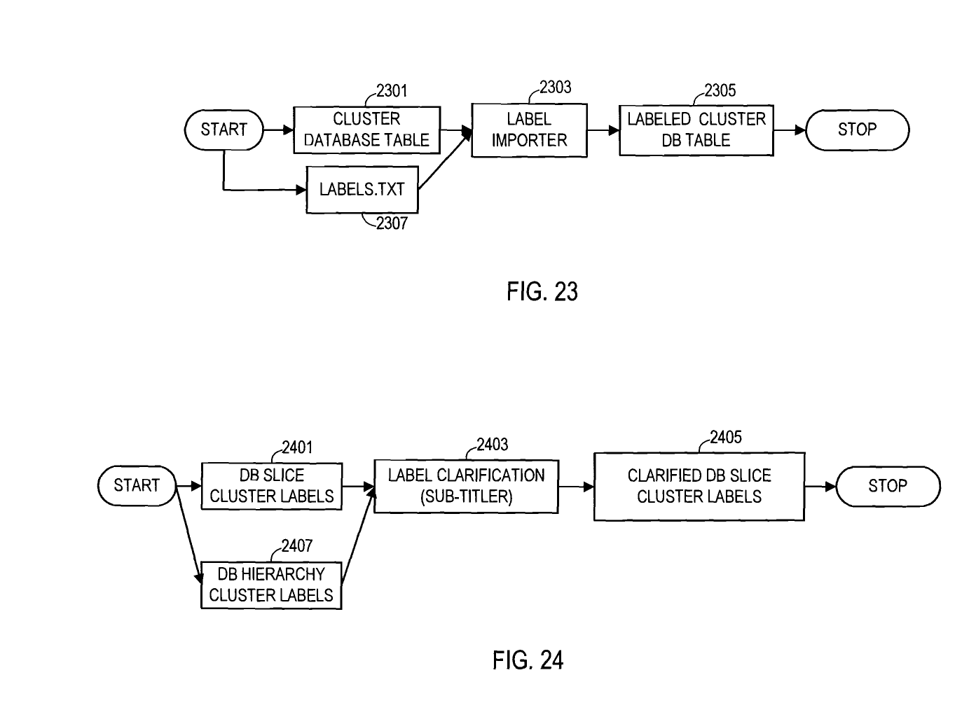

Now referring to the flow chart of FIG. 23, the Label Import process (see 2303) is a simple script procedure. The php cluster_labels_import.php labelsFile clusterTypeId command is used for this process. It is only run when new cluster label data is available, for example once every 3 months. For inputs, this is a cluster label file in text format, shown at 2307, consisting of a development id ? label (although, without the ?). Another input is the cluster type id, to use in retrieving the cluster table, at 2301. As outputs, these are a plurality of update statements against the database, at 2305, leaving the respective table labeled with the contents of the file.

### Labeling Clarification

Now referring to the flow chart of FIG. 24, this process (see 2404) dumps the labels and the hierarchy from the database and uses the labels in the hierarchy, at 2407 to clarify duplicate labels in the slice by appending the labels of the children of those clusters.

The php clarify_cluster_labels.php hierarchyTypeId sliceTypeId command is used for this process. It is only run when new cluster labeling data is available, hypothetically once every 3 months, the cluster type ids of the hierarchy, at 2407, and the slice are inputs at 2401, and relabeled slice clusters 2405 in the database are outputs.

### Cluster Merging Process Example

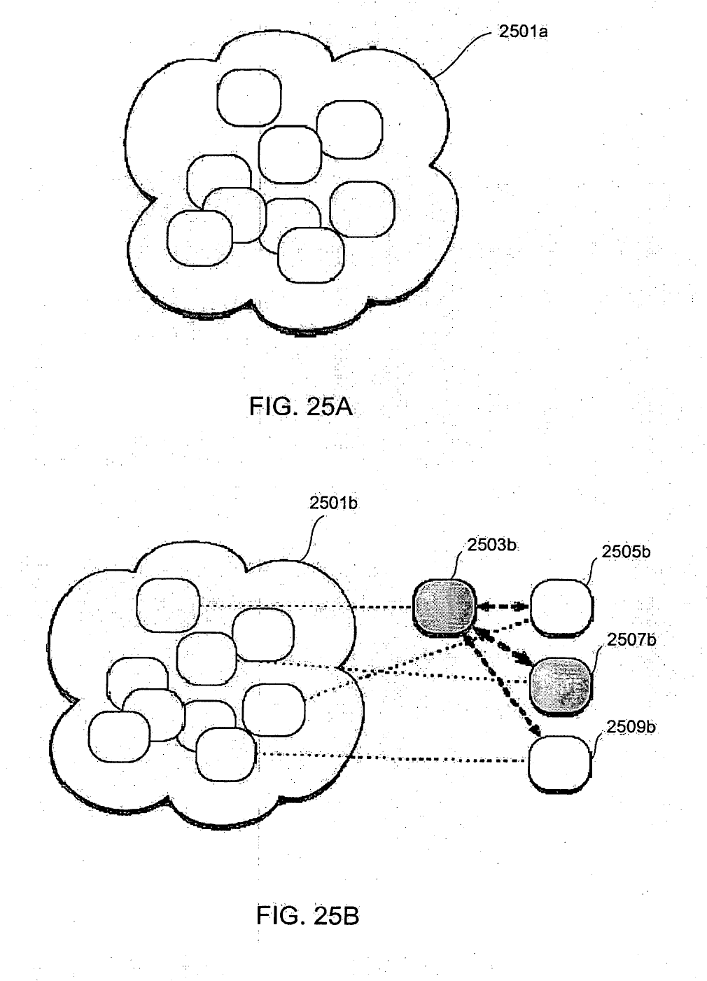

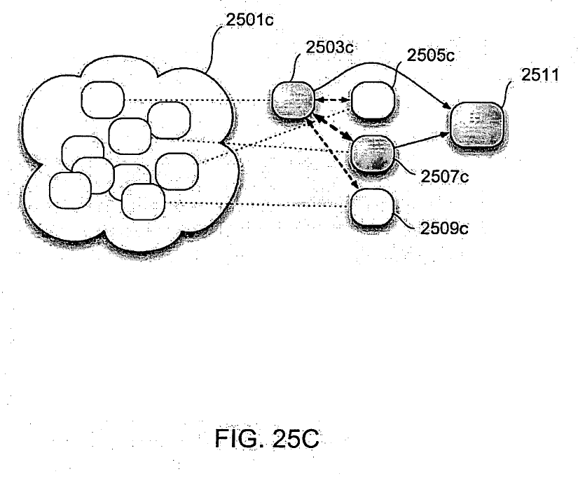

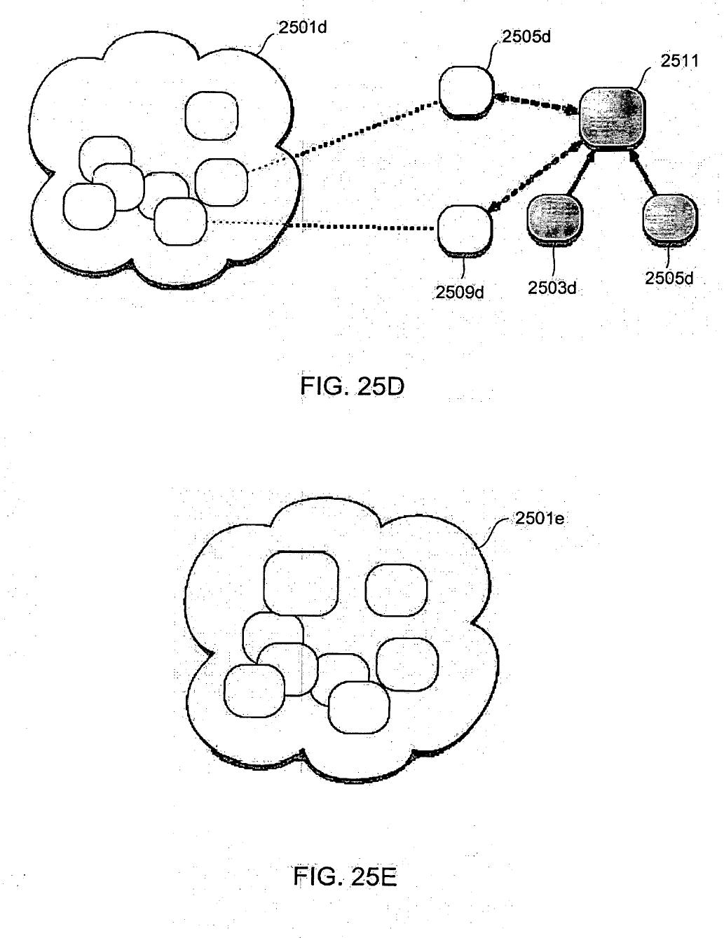

Once clusters are created, the system refines them based on their relationships into large units. The system starts with something akin to the to the diagram of FIG. 25A. Next, referring to the diagram of FIG. 25B and steps at 2503-2509, for every cluster, in 2501b the system finds all of those with which each of the clusters shares some patent-level similarity. With reference now to the diagram of FIG. 25C, the cluster with which the greatest similarity (e.g. 2503-2509) exists merges with the query cluster to form a larger cluster. As shown in the diagram of FIG. 25D, similarities to this new cluster are calculated while the old clusters from which it is formed are moved from the cluster set 2501d. Finally, now referring to the diagram of FIG. 25E, the new cluster is placed in the set 2501e so that the process can continue.

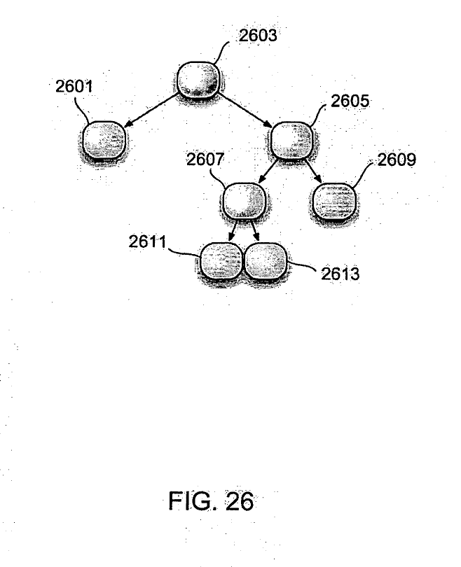

By keeping track of the information in the merging steps, at the end, the system has one or more cluster hierarchies, with clusters 2601-2613 shown in FIG. 26. The diagram of FIG. 26 is an example of one such hierarchy, showing the intermediate merge steps and the “root” step.

### Intergenerational Mapping

After the cluster merging process and cluster labeling process are complete, for a given point in time, a large database of technical literature has essentially been clustered and characterized, through labeling. Over time, the entire process can be re-run over an evolving data set at regular intervals. At each interval, each cluster must be related to the clusters that formed before it. Through this process of intergenerational mapping, a graph can be built showing the relationships in a new dimension, as compared to the graph that exists for a static point in time. By comparing the differences in labels over time, the evolution of the technical literature can be observed.

The clustering method employs temporally static heuristics on an ever evolving data set, and a technique has been developed to map between clusterings taken at different points in time. As new patents are issued, new clusters may form, prior patents may become identified as spam of have gained too much popularity, while preexisting clusters may be altered and combined into different hierarchies. Thus, for every pair of temporally distinct sets of clusters, there is no one-to-one correspondence. A many-to-many model of the relationships between clusters is built, which may be referred to as an intergenerational map. This is accomplished by examining the one-to-one map between generations of fingerprints.

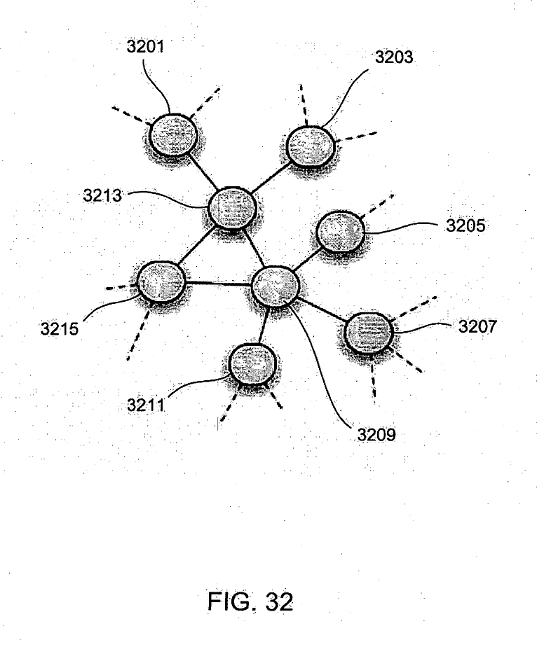

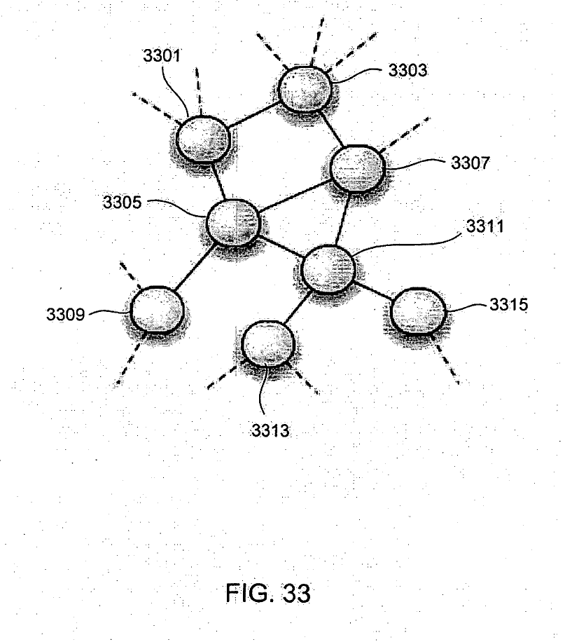

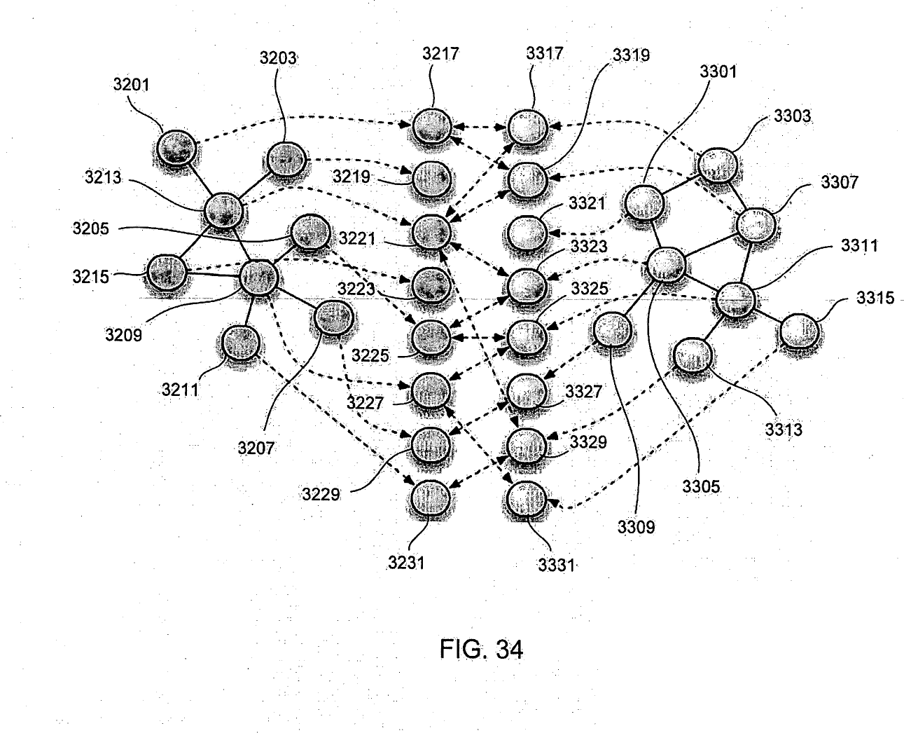

The diagrams shown in FIGS. 32-35 represent the networks of clusters taken at any two points in time, where FIG. 32 shows a first network 3200 of clusters 3201-3215 at, a first point in time and FIG. 33 shows a second network 3300 of clusters 3301-3315 at a second point in time. The many-to-many relationships which exist between clusters from different generations encapsulates and demonstrates that a cluster may remain relatively unchanged, become divided, and/or combine with other clusters (see FIG. 34). New clusters also come into existence.

The process of intergenerational mapping includes the following steps: mapping the identifier spaces; mapping the fingerprints; and, mapping the clusters. All of these steps rely on intermediate products generated during individual clustering runs.

The step of mapping the identifier spaces is necessary because of the particular design for operating on heterogenous data, for which the inputs of two clusterings may only overlap in part. The step includes finding all identifiers common to the two generations and recording their shared relationship. With regard to the step of mapping the fingerprints, fingerprints from different generations are related by the citations that formed them, but they are not guaranteed to have the same name. Therefore, this step utilizes the previously built identifier map. It is therefore nearly identical to building the identifier map. With regard to the step of mapping the clusters, the composition of clusters is derived from fingerprints, and every cluster is associated with a set of fingerprints haying unique membership. The intergenerational map between clusters, shown in FIG. 34, leverages these factors. The relationship between two clusters of different generations is measured in relation to the percentage of shared fingerprints.

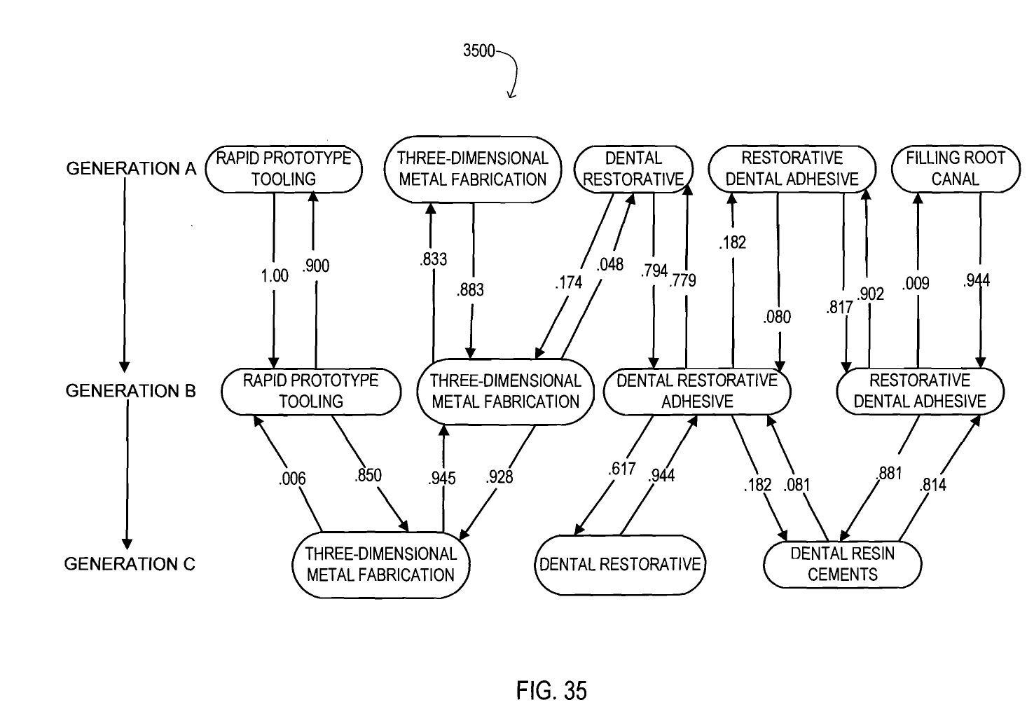

In the example shown in FIG. 35, clusterings are shown for multiple months, where each month is related using the above described technique. The directed edges represent the percentage of fingerprints found in the source which are also in the target. These numbers do not necessarily add up to one, since fingerprints are created or destroyed over time. Specifically, patents issued in Generation B on adhesives clarifies an understanding of certain three-dimensional rapid prototyping techniques. This event signifies the divergence of technologies into individual fields.

### Cluster Visualization

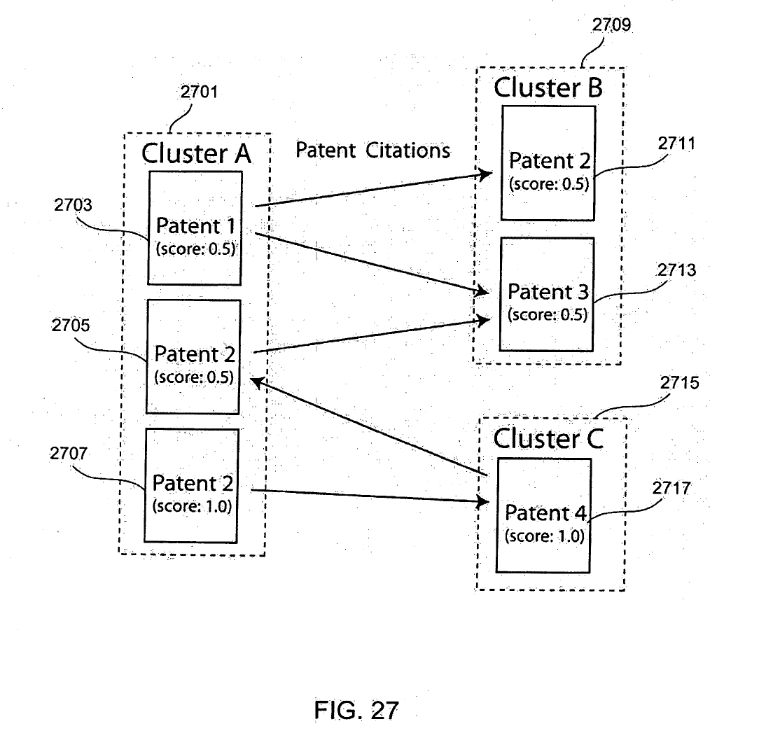

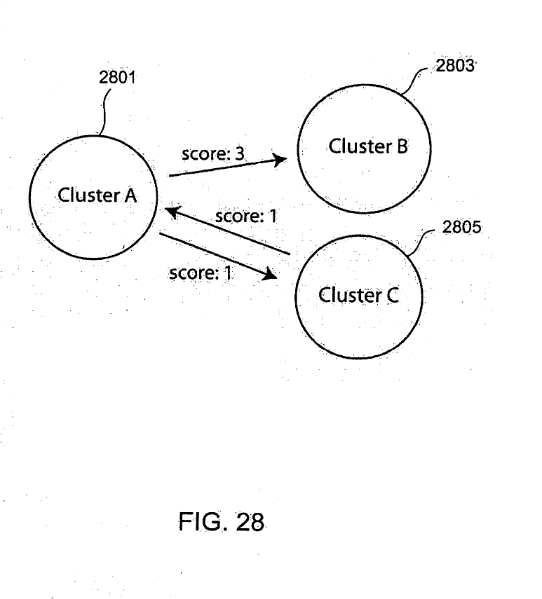

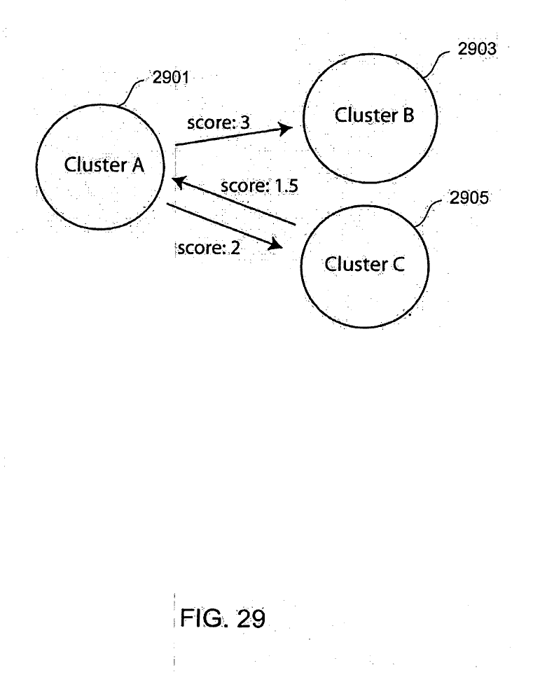

The visualization interface of the present invention enables the display and exploration of the context and connections between patent clusters. Clusters are defined through analysis of patent citations, inventor or USPTO examiner defined relationships between related patents. Just as patents can be formed into clusters through examination of citations, the resulting clusters can also be connected to each other through analysis of the aggregated citations of patents contained within the cluster. For example, as shown in the diagram of FIG. 27, two patents contained in Cluster A (2701), cite patents contained in Cluster B (2709), indicating a connection between these clusters, as shown in FIG. 28. These cluster-to-cluster links (shown between clusters 2701-2703 and 2701-2705) can be further refined by weighting citation connections between patents with the significance score of the patents within their respective cluster. If the patents in Cluster A (2801) cite patents in Cluster B (2803) that are peripheral to that cluster, then it can be inferred that the connection between A and B is less strong than if the cited set within B were core patents. FIG. 29 shows an alternative scoring of the cluster-to-clusters links (again, shown between clusters, as described with reference to FIG. 27, calculated by summing the scores of the citing and cited patent. These cluster-to-cluster connections can be assigned scores signifying the strength of bond between any two clusters within the cluster set and in an ideal case these bonds demonstrate the conceptual connectedness or overlap of any two given clusters. As a result of these connections, a graph can be constructed that show the connectedness between any given cluster and its conceptually adjacent clusters.

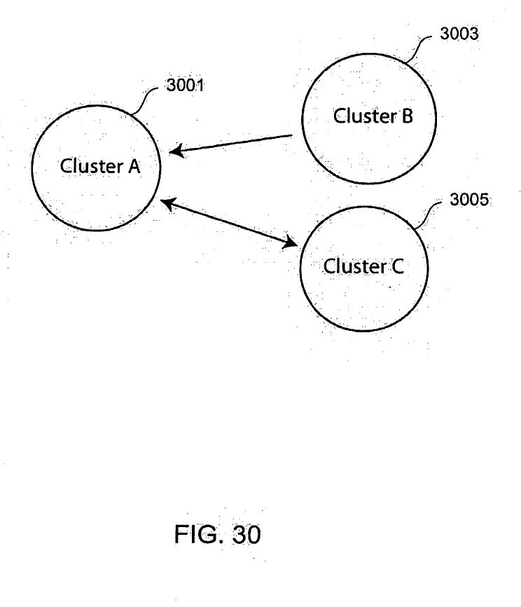

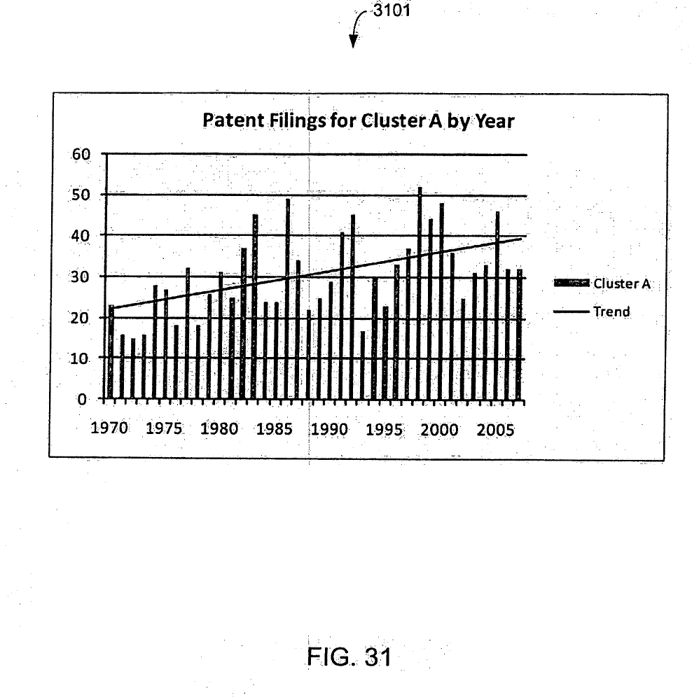

In addition to connectedness between clusters, the graph also describes directionality of connection. As shown in FIG. 30, if Cluster A (3001) cites Cluster B (3003) and B does not cite A, this could demonstrate a conceptual flow from B to A (citations are backward looking, such that flow of impact follows citations in a reverse direction). Also, as citations within clusters are connected to specific patents, the underlying patent to patent citation graph contains a temporal dimension with each cluster and each citing and cited subset of a cluster having a specific temporal distribution based on the date of filing or issue of the patents making up that set, shown in the graph 3101 of FIG. 31. These distributions can also show temporal trends in connections between clusters. For example, if the average year of filing for the set of patents in Cluster A citing Cluster B is 1989 and the average year of filing for the citing set of A to C is 1998, then this could show a shift of importance from B to C for Cluster A over that period. Taking the mean year of filing for a given patent set is only one example of the kind of temporal analysis possible using cluster-to-cluster connections. As another example, also shown in FIG. 31, it is possible to determine trend lines based on the slope of the distribution (i.e. is the connectedness of A to B increasing or decreasing) and further investigation will likely result in additional possibilities for analysis.

The resulting graph, e.g. 120, FIG. 1, demonstrating conceptual connectedness, flow of connection and temporal distribution can then be visualized to help users, such as the user of visualization means 115 of the computerized system 100, understand the contextual significance of a given patent or to find related or derivative patents based on a given starting point. By combining patent clusters with cluster to cluster links and cluster labels, the system is able to provide an intuitive spatial layout, or map, of clusters within a given community, along with a high-level description of their content. This map is not an absolute representation of the structure of all clusters, but instead a relative approximation of the conceptual layout of a given set of clusters in spatial terms. This translation from the conceptual domain into a relative spatial representation is done by processing the cluster to cluster graph with a graph layout algorithm. Each cluster within the graph is represented as a node with edges to its top-most adjacent nodes (in our current implementation the top four adjacent nodes are considered) depending on the configuration of the visualization the strength of the connection can be used to weight each edge. Using a physical model, the graph is rendered in its least energy state, with each node resting in the most optimal location relative to the other clusters in the given set. Depending on the algorithm, edge weight may also be considered during layout. There are a variety of algorithms that can be used to layout the cluster graphs, however, the Fruchterman-Reingbld force directed placement algorithm as well as the Kamada-Kawai spring minimization algorithm, are the most common approaches.

An exemplary representation of cluster neighborhoods used shows a given cluster and its four best connected neighbors, plus two iterations showing each of those neighbors subsequent neighbors. Each node can connect to any number of already existing nodes within the graph or pull in new nodes, however, no individual node can add more than a preset maximum of new nodes to the graph. Once layout is complete, the graph is converted to an XML based node and edge list and is made available for download by the client display software embedded in the website or desktop application.

An exemplary implementation of the visualization tool stores the initial cluster-to-cluster and patent-to-patent graphs as well, as the patent-to-cluster graph in a database, along, with the cluster metadata. Cluster metadata refers to the labels for the cluster and the statistics about the cluster, such as top assignees for the cluster, date histograms, and USPTO classifications.

Querying the clusters can be done in a number of ways. In response to a user query, the system can match the query against the labels for the cluster, returning the matching, clusters. Further, queries can be performed against the patents contained in the clusters. Using the patent-to-cluster graph, matched patents are then compared to the clusters that contain them, and both the patents and clusters are returned. Using a scoring function provided by the search engine, the clusters are returned and ordered by the relevance of their summed patents. In an exemplary embodiment, Apache Lucene, an open source full text indexing engine, is used to index all the patents contained in the clusters. The index contains all the text of the patents as well as their unique identifiers in the database. After the ordered cluster list is returned to the user, a specific cluster can be selected. Scripts are written to query the cluster and patent graphs, based on a given starting point (most commonly, a specific cluster, but it can also be a collection of clusters matching some other criteria), extracting top most adjacent clusters and their connecting edges. This extracted graph is then fed into an implementation of the previously mentioned layout algorithms. AT&T Graph Viz may be used, which is an open source tool that implements both Fruchterman-Reingold and Kamada-Kawai and is optimized for layout of large complex graphs. In the Graph Viz based implementation, a “.dot” file is generated by the script, describing the graph and the associated layout files. After processing by Graph Viz, a new “.dot” file can be generated with x and y coordinates associated with each node. The resulting file is then processed by the script into XML. This process can be done in real time or batch, depending on the desired solution.

An exemplary client implementation reads the resulting XML file and renders the graph. The display software is currently a Flash Applet embedded in the web page. The Flash client renders an abstract “stick and ball” model (e.g. 120, FIG. 1) to represent the nodes and edges within the graph. Factors such as cluster size (number of patents contained in the cluster) and strength of connection are also displayed in the rendering, cluster size is directly related to area of the node in the rendering and strength of connection is represented through either line weight or size of connectors at each end of the edge. Other layers of data within the graph, such as temporal distribution and cluster metadata can be shown as overlays on the graph.

In view of the foregoing detailed description of preferred embodiments of the present invention, it readily will be understood by those persons skilled in the art that the present invention is susceptible to broad utility and application. While various aspects have been described in the context of screen shots, additional aspects, features, and methodologies of the present invention will be readily discernable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention.

It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. In addition, some steps may be carried out simultaneously.

Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

What is claimed is:

1. A method of organizing a plurality of documents for later; access, and retrieval within a computerized; system, wherein the plurality of documents are contained within a dataset and wherein a class of documents contained in the dataset include one or more citations to one or more other documents, comprising the steps of:
creating a set of fingerprints for each respective document in the class, wherein each fingerprint comprises one or more citations contained in the respective document;
creating a plurality of clusters for the dataset based on the sets of fingerprints for the documents in the class;
assigning each respective document in the class to zero or more of the clusters based on the set of fingerprints for said respective document and wherein each respective cluster has documents assigned thereto based on a statistical similarity between the sets of fingerprints of said assigned documents;
for each remaining document in the dataset that has not yet been assigned to at least one cluster, assigning each said remaining document to one or more of the clusters based on a natural language processing comparison of each said remaining document with documents already assigned to each respective cluster;
creating a descriptive label for each respective cluster based on key terms contained in the documents assigned to the respective cluster; and
presenting one or more of the labeled clusters to a user of the computerized system.

2. The method of claim 1, wherein the dataset comprises one or more of issued patents, patent applications, technical disclosures, and technical literature.

3. The method of claim 1, wherein the citation is a reference to an issued patent, published patent application, case, lawsuit, article, website, statute, regulation, or scientific journal.

4. The method of claim 1, wherein the citations reference documents only in the dataset.

5. The method of claim 1, wherein the citations reference documents both in and, outside of the dataset.

6. The method of claim 1, wherein each fingerprint further comprises a reference to the respective document containing the one of more citations.

7. The method of claim 1, wherein the set of fingerprints for each respective document is based on all of the citations contained in the respective document.

8. The method of claim 1, wherein the set of fingerprints for each respective document is based on a sampling of the citations contained in the respective document.

9. The method of claim 1, wherein the step of creating the plurality of clusters for the dataset is based on the sets of fingerprints for only a subset of documents in the class.

10. The method of claim 1, further comprising the steps of identifying spurious citations contained in documents in the class and excluding the spurious citations from consideration during the step of creating the set of fingerprints.

11. The method of claim 10, wherein the step of excluding the spurious citations from consideration causes some documents to be excluded from the class.

12. The method of claim 1, further comprising the steps of identifying spurious citations contained in documents in the class and then excluding any documents having spurious citations from the class.

13. The method of claim 1, further comprising the step of identifying spurious citations contained in documents in the class, wherein spurious citations include citations that (i) are part of a spam citation listing, (ii) are a reference to a key work document, or (iii) are a
reference to another document having an overlapping relationship with the document containing the respective citation.

14. The method of claim 13, wherein the spam citation listing comprises a list of citations that are repeated in a predetermined number of documents.

15. The method of claim 13, wherein the key work document is a document cited by a plurality of documents that exceeds a predetermined threshold.

16. The method of claim 13, wherein the overlapping relationship comprises the same inventor, assignee, patent examiner, title, or legal representative between the document referenced by the respective citation and me document containing the respective citation.

17. The method of claim 13, wherein the overlapping relationship comprises the same author, employer, publisher, publication, source, or title between the document referenced by the respective citation and the document containing the respective citation.

18. The method of claim 1, further comprising the step of reducing the plurality of clusters by merging pairs of clusters as a factor of (i) the similarity between documents assigned to the pairs of clusters and (ii) the number of documents assigned to each of the pairs of clusters.

19. The method of claim 18, wherein the merging of pairs of clusters is accomplished as a factor of the difference in the number of documents assigned to each of the pairs of clusters.

20. The method of claim 1, further comprising the step of reducing the plurality of clusters by progressively merging pairs of lower level clusters to define a higher level cluster.

21. The method of claim 1, further comprising the step of assigning each respective document in the class to zero or more of the clusters based on an n-step analysis of documents cited directly or transitively by each respective document.

22. The method of claim 1, wherein the plurality of clusters are arranged in hierarchical format, with a larger number of documents assigned to higher-level clusters and with fewer documents assigned to lower-level, more specific clusters.

23. The method of claim 22, wherein the step of creating descriptive labels for each respective cluster comprises creating general labels for the higher-level clusters and progressively more specific labels for the smaller, lower-level clusters.

24. The method of claim 22, wherein the step of creating descriptive labels for each respective cluster is performed in a bottom-up and top-down approach.

25. The method of claim 1, wherein the descriptive label for one of the respective clusters includes at least one key term from the documents assigned to the respective cluster.

26. The method of claim 1, wherein the descriptive label for one of the respective clusters is derived from but does not include key terms from the documents assigned to the respective cluster.

27. The method of claim 1, wherein the step of assigning each said remaining document to one or more of the clusters based on the natural language processing comparison comprises comparing key terms contained in each of said remaining, documents with key terms contained in documents already assigned to each respective cluster.

28. The method of claim 1, wherein the step of assigning each said remaining document to one or more of the clusters based on the natural language processing comparison comprises running a statistical n-gram analysis.

29. The method of claim 1, wherein the step of presenting one or more of the labeled clusters to the user comprises displaying the labeled clusters to the user on a computer screen.

30. The method of claim 1, wherein the step of presenting one or more of the labeled clusters to the user comprises providing the user with access to one or more of the documents assigned to the one or more of the labeled clusters.

31. The method of claim 1, wherein the step of presenting one or more of the labeled clusters to the user comprises providing the user with access to portions of the documents assigned to the one or more labeled clusters.

32. The method of claim 1, wherein the step of presenting one pr more of the labeled clusters to the user is in response to a request by the user.

33. In a computerized system, a method of organizing documents in a dataset of a plurality of documents, wherein a class of documents contained in the dataset include one or more citations to one or more other documents, comprising the steps of:
for each document in the class, creating a set of fingerprints, wherein each fingerprint identifies one or more citations contained in the respective document;
based on the sets of fingerprints for the documents in the class, creating a plurality of clusters for the dataset, wherein each cluster is defined as an overlap of fingerprints from two or more documents in the class;
assigning documents in the class to zero or more of the clusters based on the citations contained in each respective document;
assigning all remaining documents in the dataset, that have not yet been assigned to at least one cluster, to one or more clusters based on a natural language processing comparison of each said remaining document with documents already assigned to each respective cluster;
creating a label for each respective cluster based on key terms contained in the documents assigned to the respective cluster; and
providing to a user of the computerized system access to documents assigned to one or more clusters in response to a request by the user.

34. The method of claim 33, wherein the dataset comprises one or more of issued patents, patent applications, technical disclosures, and technical literature.

35. The method of claim 33, wherein the citation is a reference to an issued patent, published patent application, case, lawsuit, article, website, statute, regulation, or scientific journal.

36. The method of claim 33, wherein the citations reference documents only in the dataset.

37. The method of claim 33, wherein the citations reference documents both in and outside of the dataset.

38. The method of claim 33, wherein each fingerprint further comprises a reference to the respective document containing the one or more citations.

39. The method of claim 33, wherein the set of fingerprints for each respective document is based on all of the citations contained in the respective document.

40. The method of claim 33, wherein the set of fingerprints for each respective document is based on a sampling of the citations contained in the respective document.

41. The method of claim 33, wherein the step of creating the plurality of clusters for the dataset is based on the sets of fingerprints for only a subset of documents in the class.

42. The method of claim 33, further comprising the steps of identifying spurious citations contained in documents in the class and excluding the spurious citations from consideration during the step of creating the set of fingerprints.

43. The method of claim 42, wherein the step of excluding the spurious citations from consideration causes some documents to be excluded from the class.

44. The method of claim 33, further comprising the steps of identifying spurious citations contained in documents in the class and then excluding any documents having spurious citations from the class.

45. The method of claim 33, further comprising the step of identifying spurious citations contained in documents in the class, wherein spurious citations include citations that (i) are part of a spam citation listing, (ii) are a reference to a key work document, or (iii) are a reference to another document having ah overlapping relationship with the document containing the respective citation.

46. The method of claim 45, wherein the spam citation listing comprises a list of citations that are repeated in a predetermined number of documents.

47. The method of claim 45, wherein the key work document is a document cited by a plurality of documents that exceeds a predetermined threshold.

48. The method Of claim 45, wherein the overlapping relationship comprises the same inventor, assignee, patent examiner, title, or legal representative between the document referenced by the respective citation and the document containing the respective citation.

49. The method of claim 45, wherein the overlapping relationship comprises the same author, employer, publisher, publication, source, or title between the document referenced by the respective citation and the document containing the respective citation.

50. The method of claim 33, further comprising the step of reducing the plurality of clusters by merging pairs of clusters as a factor of (i) the similarity between documents assigned to the pairs of clusters and (ii) the number of documents assigned to each of the pairs of clusters.

51. The method of claim 50, wherein the merging of pairs of clusters is further accomplished as a factor of the difference in the number of documents assigned to each of the pairs of clusters.

52. The method of claim 33, further comprising the step of reducing the plurality of clusters by progressively merging pairs of lower-level clusters to define a respective higher-level cluster.

53. The method of claim 33, further comprising the step of assigning each respective document in the class to zero or more of the clusters based on an n-step analysis of documents cited directly or transitively by each respective document.

54. The method of claim 33, wherein the plurality of clusters are arranged in hierarchical format, with a larger number of documents assigned to higher-level clusters and with fewer documents assigned to lower-level, more specific clusters.

55. The method of claim 54, wherein the step of creating descriptive labels for each respective cluster comprises creating general labels for the higher-level clusters and progressively more specific labels for the smaller, lower-level clusters.

56. The method of claim 54, wherein the step of creating descriptive labels for each respective cluster is performed in a bottom-up and top-down approach.

57. The method of claim 33, wherein the descriptive label for one of the respective clusters includes at least one key term from the documents assigned to the respective cluster.

58. The method of claim 33, wherein the descriptive label for one of the respective clusters is derived from but does not include key terms from the documents assigned to the respective cluster.

59. The method of claim 33, wherein the step of assigning each said remaining document to one or more of the clusters based on the natural language processing comparison comprises comparing key terms contained in each of said remaining documents with key terms contained in documents already assigned to each respective cluster.

60. The method of claim 33, wherein the step of assigning each said remaining document to one or more of the clusters based on the natural language processing comparison comprises running a statistical n-gram analysis.

61. The method of claim 33, wherein the step of providing to the user of the computerized system access to documents assigned to one or more clusters comprises displaying the documents to the user on a computer screen.

62. The method of claim 33, wherein the step of providing to the user of the computerized system access to documents assigned to one or more clusters comprises first presenting the one or more clusters to the user.

63. The method of claim 33, wherein the step of providing to the user of the computerized system access to documents-assigned to one or more clusters comprises providing the user with access to portions of said documents.

64. In a computerized system, a method of organizing a plurality of documents for later access and retrieval within the computerized system, wherein the plurality of documents are contained within a dataset and wherein a class of documents contained in the dataset include one or more citations to one or more other documents, comprising the steps of:
identifying spurious citations contained in documents in the class;
creating a set of fingerprints for each document in the class, wherein each fingerprint identifies one or more citations, other than spurious citations, contained in the respective document;
creating an initial plurality of low-level clusters for the dataset based on the sets of fingerprints for the documents in the class, wherein each cluster is defined as an overlap of fingerprints from two or more documents in the class;
creating a reduced plurality of high-level clusters by progressively merging pairs of low-level clusters to define a respective high-level cluster;
assigning documents in the dataset to one or more of the clusters;
creating a label for each respective cluster based on key terms contained in the documents assigned to the respective cluster; and
selectively presenting one or more of the low-level and high-level clusters to a user of the computerized system.
